(19) United States
(12) Patent Application Publication
(10) Pub. No.: US 2026/0059210 A1
(43) Pub. Date: Feb. 26, 2026

(54) PHOTOELECTRIC CONVERSION DEVICE AND PHOTODETECTION SYSTEM

(71) Applicant: CANON KABUSHIKI KAISHA, Tokyo (JP)

(72) Inventor: HIDEYUKI ITO, Tokyo (JP)

(21) Appl. No.: 19/301,328

(22) Filed: Aug. 15, 2025

(30) Foreign Application Priority Data
Aug. 23, 2024 (JP) 2024-142355

(51) Int. Cl. H04N 25/78; H04N 25/705; H04N 25/76

(52) U.S. Cl. CPC H04N 25/78; H04N 25/705; H04N 25/7795

(57) ABSTRACT

A photoelectric conversion device includes a photoelectric conversion unit configured to output a pulse signal according to incidence of a photon, a first counter configured to count the pulse signal, an exposure control circuit configured to control a count period of the pulse signal by the first counter according to a result of a plurality of comparisons of a count value of the first counter with a predetermined threshold value during an exposure period of one frame, a second counter configured to count each time it is determined that the count value of the first counter is equal to or less than the threshold value, and a comparison circuit configured to compare a count value of the second counter in a first frame with a count value of the second counter in a second frame before the first frame and output event information according to a comparison result.

### BACKGROUND

### Field of the Technology

The present disclosure relates to a photoelectric conversion device and a photodetection system.

### Description of the Related Art

A single photon avalanche diode (SPAD) is known as a detector capable of detecting weak light at a single photon level. The SPAD uses an avalanche multiplication phenomenon generated by a strong electric field induced in a p-n junction of a semiconductor to multiply a signal charge excited by a photon to about several times to several million times. By converting the current generated by the avalanche multiplication phenomenon into a pulse signal and counting the number of pulse signals, it is possible to directly measure the number of incident photons.

Japanese Patent Laid-Open No. 2023-039400 describes a photoelectric conversion device that performs a combination of a recharging method in which SPAD is periodically recharged and a method in which a counting operation is performed for each pixel with an accumulation time corresponding to the brightness of an object. According to the photoelectric conversion device described in Japanese Patent Laid-Open No. 2023-039400, it is possible to realize an increase in dynamic range and a reduction in power consumption.

On the other hand, an event detection sensor that detects a change in luminance and outputs the change as an event is attracting attention, and it is considered that an event detection function is also installed in the SPAD sensor. However, when it is assumed that the event detection function is mounted on the photoelectric conversion device described in Japanese Patent Laid-Open No. 2023-039400, a multi-bit information holding memory and a large-scale comparison circuit are required, and there is a concern that the pixel circuit scale increases and power consumption increases.

### SUMMARY

The present disclosure is directed to a photoelectric conversion device and a photodetection system capable of realizing acquisition of a high dynamic range image and event detection while suppressing power consumption.

According to an aspect of the present disclosure, there is provided a photoelectric conversion device including a photoelectric conversion unit configured to output a pulse signal in response to incidence of a photon, a first counter configured to count the pulse signal, an exposure control circuit configured to control a count period of the pulse signal by the first counter according to a result of a plurality of comparisons of a count value of the first counter with a predetermined threshold value during an exposure period of one frame, a second counter configured to count each time it is determined that the count value of the first counter is equal to or less than the threshold value, and a comparison circuit configured to compare a count value of the second counter in a first frame with a count value of the second counter in a second frame before the first frame and output event information according to a comparison result.

According to another aspect of the present disclosure, there is provided a photoelectric conversion device including a photoelectric conversion unit configured to output a pulse signal in response to incidence of a photon, a first counter configured to count the pulse signal, a second counter configured to count a time until the first counter reaches a predetermined threshold value, and a comparison circuit configured to compare a count value of the second counter in a first frame with a count value of the second counter in a second frame before the first frame and output event information according to a comparison result.

Features of the present disclosure will become apparent from the following description of embodiments with reference to the attached drawings. The following description of embodiments is described by way of example.

### BRIEF DESCRIPTION OF THE DRAWINGS

FIG. 1 and FIG. 2 are block diagrams illustrating schematic configurations of a photoelectric conversion device according to a first embodiment.

FIG. 3 is a block diagram illustrating a configuration example of a pixel of the photoelectric conversion device according to the first embodiment.

FIG. 4 is a perspective view illustrating a configuration example of the photoelectric conversion device according to the first embodiment.

FIG. 5A, FIG. 5B, and FIG. 5C are diagrams illustrating the basic operation of the pixel in the photoelectric conversion device according to the first embodiment.

FIG. 6 is a block diagram illustrating a configuration example of the pixel of the photoelectric conversion device according to the first embodiment.

FIG. 7 is a flowchart illustrating a method of driving the pixel of the photoelectric conversion device according to the first embodiment.

FIG. 8 and FIG. 9 are timing charts illustrating operation examples of the pixel of the photoelectric conversion device according to the first embodiment.

FIG. 10 is a block diagram illustrating a configuration example of a pixel of a photoelectric conversion device according to a second embodiment.

FIG. 11 is a block diagram illustrating a configuration example of a pixel of a photoelectric conversion device according to a third embodiment.

FIG. 12 is a block diagram illustrating a schematic configuration of a photodetection system according to a fifth embodiment.

FIG. 13 is a block diagram illustrating a schematic configuration of a range image sensor according to a sixth embodiment.

FIG. 14 is a schematic diagram illustrating a configuration example of an endoscopic surgical system according to a seventh embodiment.

FIG. 15A, FIG. 15B, and FIG. 15C are schematic diagrams illustrating a configuration example of a movable object according to an eighth embodiment.

FIG. 16 is a block diagram illustrating a schematic configuration of a photodetection system according to the eighth embodiment.

FIG. 17 is a flowchart illustrating the operation of the photodetection system according to the eighth embodiment.

FIG. 18A and FIG. 18B are schematic diagrams illustrating a schematic configuration of a photodetection system according to a ninth embodiment.

### DESCRIPTION OF THE EMBODIMENTS

Hereinafter, embodiments of the present disclosure will be described with reference to the drawings. In each of the embodiments described below, as an example of the photoelectric conversion device, a device used for imaging will be mainly described. However, each embodiment is not limited to a device for the imaging application and may be applied to other examples included as a photoelectric conversion device. For example, the other examples may include a distance measuring device (a device for measuring distance using focus detection, time-of-flight (TOF), and the like), a photometric device (a device for measuring the amount of incident light), and the like.

Note that the conductivity type of the transistor described in the embodiments described below is merely an example and is not limited to the conductivity type described in the embodiments. The conductivity type may be appropriately changed with respect to the conductivity type described in the embodiments, and the potentials of the gate, the source, and the drain of the transistor are appropriately changed in accordance with the change. For example, in the case of a transistor operating as a switch, low-level and high-level of the potential supplied to the gate may be reversed with respect to the description in the embodiments as the conductivity type is changed.

In the following embodiments, connection between elements of a circuit may be described. In this case, even when another element is interposed between the elements of interest, the elements of interest are treated as being connected to each other unless otherwise specified. For example, it is assumed that an element A is connected to one node of a capacitor C having a plurality of nodes, and an element B is connected to the other node. Even in such a case, the element A and the element B are regarded as being connected to each other unless otherwise specified.

The following embodiments are intended to embody the technical idea of the present disclosure, and do not limit the present disclosure. The sizes and positional relationships of members illustrated in the drawings may be exaggerated for clarity of description. In the following description, the same components are denoted by the same reference numerals, and the description thereof may be omitted.

### First Embodiment

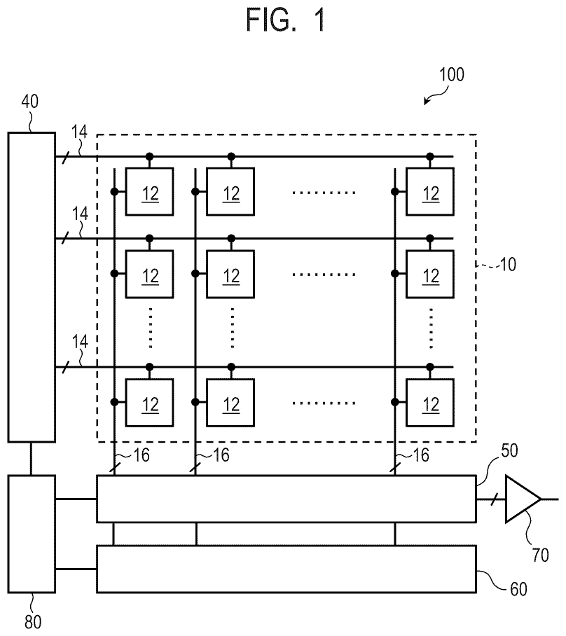

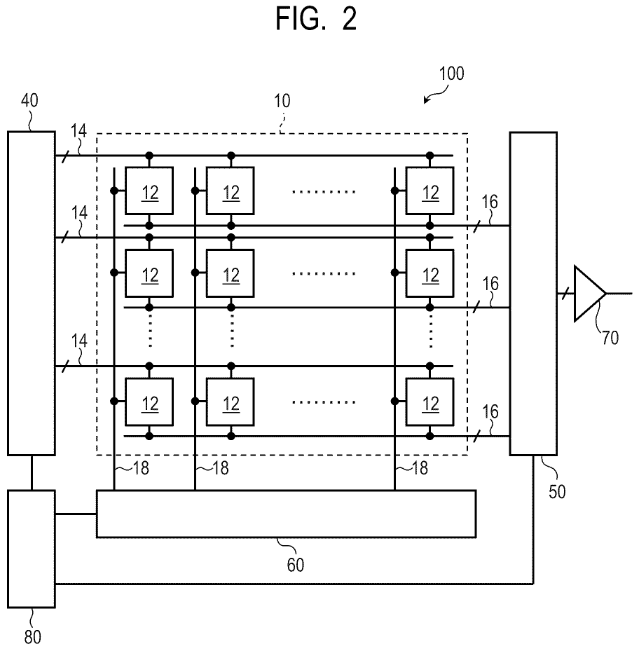

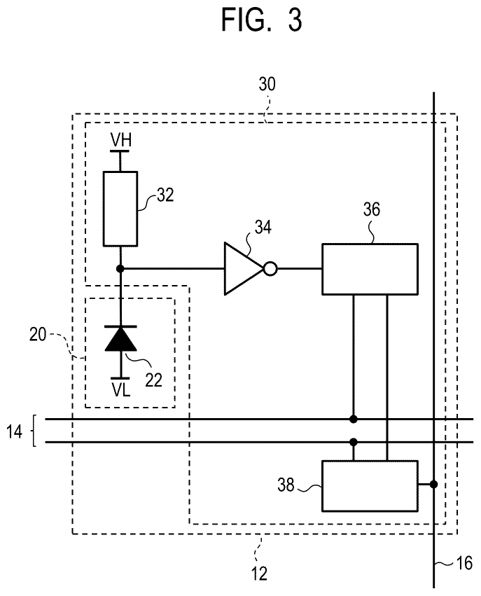

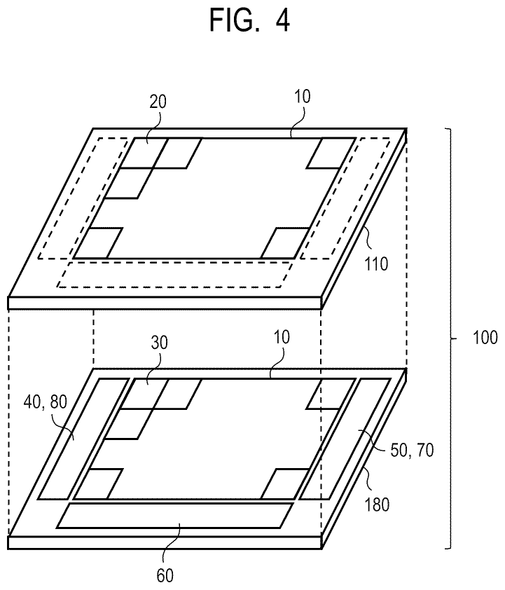

A schematic configuration of a photoelectric conversion device according to a first embodiment will be described with reference to FIG. 1 to FIG. 4. FIG. 1 and FIG. 2 are block diagrams illustrating schematic configurations of the photoelectric conversion device according to the present embodiment. FIG. 3 is a block diagram illustrating a configuration example of a pixel of the photoelectric conversion device according to the present embodiment. FIG. 4 is a perspective view illustrating a configuration example of the photoelectric conversion device according to the present embodiment.

As illustrated in FIG. 1, the photoelectric conversion device 100 according to the present embodiment includes a pixel unit 10, a vertical scanning circuit unit 40, a readout circuit unit 50, a horizontal scanning circuit unit 60, an output circuit unit 70, and a control pulse generation unit 80.

The pixel unit 10 is provided with a plurality of pixels 12 arranged in an array so as to form a plurality of rows and a plurality of columns. As described later, each pixel 12 may include a photoelectric conversion unit including a photoelectric conversion element and a signal processing circuit unit that processes a signal output from the photoelectric conversion unit. The number of pixels 12 included in the pixel unit 10 is not particularly limited. For example, like a general digital camera, the pixel unit 10 may be constituted by a plurality of pixels 12 arranged in an array of several thousand rows×several thousand columns. Alternatively, the pixel unit 10 may include a plurality of pixels 12 arranged in one row or one column. Alternatively, the pixel unit 10 may include one pixel 12.

In each row of the pixel array of the pixel unit 10, a control line 14 is arranged so as to extend in a first direction (lateral direction in FIG. 1). Each of the control lines 14 is connected to the pixels 12 arranged in the first direction on the corresponding row, respectively, and forms a signal line common to these pixels 12. The first direction in which the control lines 14 extend may be referred to as a row direction or a horizontal direction. Each of the control lines 14 may include a plurality of signal lines for supplying a plurality of types of control signals to the pixels 12. The control line 14 of each row is connected to the vertical scanning circuit unit 40.

Further, in each column of the pixel array of the pixel unit 10, an output line 16 is arranged so as to extend in a second direction (vertical direction in FIG. 1) intersecting the first direction. Each of the output lines 16 is connected to the pixels 12 arranged in the second direction on the corresponding column, respectively, and forms a signal line common to these pixels 12. The second direction in which the output line 16 extends may be referred to as a column direction or a vertical direction. Each of the output lines 16 may include a plurality of signal lines such as signal lines for transferring a digital signal of a plurality of bits output from the pixel 12 for each bit.

The control line 14 of each row is connected to the vertical scanning circuit unit 40. The vertical scanning circuit unit 40 is a control unit having a function of generating a control signal for driving the pixels 12 in response to a control signal output from the control pulse generation unit 80 and supplying the generated control signal to the pixels 12 via the control line 14. A logic circuit such as a shift register or an address decoder may be used as the vertical scanning circuit unit 40. The vertical scanning circuit unit 40 scans the pixels 12 in the pixel unit 10 in units of rows to thereby output pixel signals from the pixels 12 to the readout circuit unit 50 via the output line 16.

The output line 16 of each column is connected to the readout circuit unit 50. The readout circuit unit 50 includes a plurality of holding units (not illustrated) provided corresponding to each column of the pixel array of the pixel unit 10 and has a function of holding the pixel signals of the pixels 12 output from each column of the pixel unit 10 in units of rows via the output lines 16 in the holding units of the respective columns.

The horizontal scanning circuit unit 60 is a control unit that generates a control signal for reading out a pixel signal from the holding unit of each column of the readout circuit unit 50 in response to a control signal output from the control pulse generation unit 80 and supplies the generated control signal to the readout circuit unit 50. A logic circuit such as a shift register or an address decoder may be used as the horizontal scanning circuit unit 60. The horizontal scanning circuit unit 60 scans the holding units of the readout circuit unit 50 in units of columns to thereby sequentially output the pixel signals held in the holding units of the respective columns to the output circuit unit 70.

The output circuit unit 70 is a circuit unit that includes an external interface circuit and is configured to output the pixel signal output from the readout circuit unit 50 to the outside of the photoelectric conversion device 100. The external interface circuit included in the output circuit unit 70 is not particularly limited. As the external interface circuit, for example, a SERializer/DESerializer (SerDes) transmission circuit may be applied. Examples of the SerDes transmission circuit include a low voltage differential signaling (LVDS) circuit, a scalable low voltage signaling (SLVS) circuit, and the like.

The control pulse generation unit 80 is a control circuit for generating a control signal for controlling the operations and timings thereof of the vertical scanning circuit unit 40, the readout circuit unit 50, and the horizontal scanning circuit unit 60 and supplying the generated control signal to each functional block. At least a part of the control signals for controlling the operations and timings thereof of the vertical scanning circuit unit 40, the readout circuit unit 50, and the horizontal scanning circuit unit 60 may be supplied from the outside of the photoelectric conversion device 100.

The connection mode of each functional block of the photoelectric conversion device 100 is not limited to the configuration example of FIG. 1 and may be configured as illustrated in FIG. 2, for example.

In the configuration example of FIG. 2, the output line 16 extending in the first direction is arranged in each row of the pixel array of the pixel unit 10. Each of the output lines 16 is connected to the pixels 12 arranged in the first direction on the corresponding row, respectively, and forms a signal line common to these pixels 12. A control line 18 extending in the second direction is arranged in each column of the pixel array of the pixel unit 10. Each of the control lines 18 is connected to the pixels 12 arranged in the second direction on the corresponding column, respectively, and forms a signal line common to the pixels 12.

The control line 18 of each column is connected to the horizontal scanning circuit unit 60. The horizontal scanning circuit unit 60 generates a control signal for reading out a pixel signal from the pixel 12 in response to a control signal output from the control pulse generation unit 80 and supplies the generated control signal to the pixel 12 via the control line 18. Specifically, the horizontal scanning circuit unit 60 scans the plurality of pixels 12 of the pixel unit 10 in units of columns to thereby output the pixel signal of the pixel 12 of each row belonging to the selected column to the corresponding output line 16.

The output line 16 of each row is connected to the readout circuit unit 50. The readout circuit unit 50 includes a plurality of holding units (not illustrated) provided corresponding to each row of the pixel array of the pixel unit 10 and has a function of holding the pixel signals of the pixels 12 output from each row of the pixel unit 10 in units of columns via the output lines 16 in the holding units of the respective rows.

The readout circuit unit 50 sequentially outputs the pixel signals held in the holding units of the respective rows to the output circuit unit 70 in response to the control signal output from the control pulse generation unit 80. Other configurations in the configuration example of FIG. 2 may be the same as those in the configuration example of FIG. 1.

As illustrated in FIG. 3, each pixel 12 includes a photoelectric conversion unit 20 and a signal processing circuit unit 30. The photoelectric conversion unit 20 is a functional block that converts incident light into an electrical signal and includes a photoelectric conversion element. The signal processing circuit unit 30 is a functional block that performs predetermined signal processing on a signal output from the photoelectric conversion unit 20 and may include, for example, a quenching circuit 32, a waveform shaping circuit 34, a counter circuit 36, and a selection circuit 38. The signal processing circuit unit 30 is not particularly limited, and may include any of the quenching circuit 32, the waveform shaping circuit 34, the counter circuit 36, and the selection circuit 38.

The photoelectric conversion unit 20 may include an avalanche photodiode (hereinafter referred to as “APD”) 22. An anode of the APD 22 is connected to a node to which a voltage VL is supplied. A cathode of the APD 22 is connected to one terminal of the quenching circuit 32. A connection node between the APD 22 and the quenching circuit 32 is an output node of the photoelectric conversion unit 20. The other terminal of the quenching circuit 32 is connected to a node to which a voltage VH higher than the voltage VL is supplied. The voltage VL and the voltage VH are set so that a reverse bias voltage sufficient for the APD 22 to perform the avalanche multiplication operation is applied. In one example, a negative high voltage is applied as the voltage VL, and a positive voltage comparable to the power supply voltage is applied as the voltage VH. For example, the voltage VL is −30 V, and the voltage VH is 3 V.

The photoelectric conversion unit 20 may include the APD 22 as described above. When a reverse bias voltage sufficient to perform the avalanche multiplication operation is supplied to the APD 22, carriers generated by light incidence cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than the breakdown voltage of the APD. The linear mode is an operation mode in which a voltage applied between the anode and the cathode is set to a reverse bias voltage close to or lower than the breakdown voltage of the APD. An APD that operates in Geiger mode is referred to as a single photon avalanche diode (SPAD). The APD 22 constituting the photoelectric conversion unit 20 may operate in a linear mode or a Geiger mode. Hereinafter, the operation in the Geiger mode will be described.

In the present embodiment, the signal is taken out from the cathode side of the APD 22. Therefore, a semiconductor region of a first conductivity type including majority carriers of the same polarity as the signal charge is an n-type semiconductor region, and a semiconductor region of a second conductivity type including carriers of the polarity different from the signal charge as the majority carrier is a p-type semiconductor region. The carriers of the first conductivity type are electrons, and the carriers of the second conductivity type are holes. The present technology is also applicable to a case where a signal is taken out from the anode side of the APD 22. In this case, a semiconductor region of the first conductivity type including majority carriers of the same polarity as the signal charge is a p-type semiconductor region, and a semiconductor region of the second conductivity type including carriers of a polarity different from the signal charge as the majority carriers is an n-type semiconductor region. Although a case where one node of the APD is set to a fixed potential will be described below, the potentials of both nodes may vary as long as the potential difference between the anode and the cathode of the APD 22 has a relationship described below.

The quenching circuit 32 has a function of converting a change in the avalanche current generated in the APD 22 into a voltage signal. In addition, the quenching circuit 32 functions as a load circuit at the time of signal multiplication by avalanche multiplication and has a function of reducing the voltage applied to the APD 22 to suppress avalanche multiplication. The operation in which the quenching circuit 32 suppresses avalanche multiplication is called a quenching operation. The quenching circuit 32 has a function of returning the voltage supplied to the APD 22 to the voltage VH by flowing a current corresponding to the voltage drop due to the quenching operation. The operation of returning the voltage supplied from the quenching circuit 32 to the APD 22 to the voltage VH is called a recharge operation. The quenching circuit 32 may include a resistor, a MOS transistor, or the like.

The waveform shaping circuit 34 includes an input node to which an output signal of the photoelectric conversion unit 20 is input and an output node. The waveform shaping circuit 34 has a function of converting an analog signal output from the photoelectric conversion unit 20 into a pulse signal. The waveform shaping circuit 34 may be configured by a logic circuit including, for example, a NOT circuit (inverter circuit), a NOR circuit, a NAND circuit, and the like. Although FIG. 3 illustrates an example in which one inverter circuit is used as the waveform shaping circuit 34, a circuit in which a plurality of inverter circuits is connected in series may be used. The output node of the waveform shaping circuit 34 is connected to the counter circuit 36.

The counter circuit 36 has an input node to which an output signal of the waveform shaping circuit 34 is input, an input node connected to the control line 14, and an output node. The counter circuit 36 has a function of counting pulses superimposed on a signal output from the waveform shaping circuit 34 and holding a count value which is a count result. The signal supplied from the vertical scanning circuit unit 40 to the counter circuit 36 via the control line 14 may include, for example, an enable signal for controlling a pulse counting period, a reset signal for resetting a count value held by the counter circuit 36, and the like. The output node of the counter circuit 36 is connected to the output line 16 via the selection circuit 38.

The selection circuit 38 has a function of switching an electrical connection state (connection or non-connection) between the counter circuit 36 and the output line 16. The selection circuit 38 switches the connection state between the counter circuit 36 and the output line 16 in accordance with a control signal supplied from the vertical scanning circuit unit 40 via the control line 14 (or a control signal supplied from the horizontal scanning circuit unit 60 via the control line 18 in the configuration example of FIG. 2). The selection circuit 38 may further include a buffer circuit for outputting a signal.

One signal processing circuit unit 30 is not necessarily provided for each pixel 12, and one signal processing circuit unit 30 may be provided for a plurality of pixels 12. In this case, the signal processing of the plurality of pixels 12 may be sequentially performed using one signal processing circuit unit 30.

The photoelectric conversion device 100 according to the present embodiment may be formed on one substrate or may be configured as a stacked-type photoelectric conversion device in which a plurality of substrates is stacked. In the latter case, as illustrated in, e.g., FIG. 4, the photoelectric conversion device may be configured as a stacked-type photoelectric conversion device in which a sensor substrate 110 and a circuit substrate 180 are stacked and electrically connected to each other. At least the photoelectric conversion unit 20 among the constituent elements of the pixels 12 may be arranged on the sensor substrate 110. In addition, the signal processing circuit unit 30 among the constituent elements of the pixels 12 may be arranged on the circuit substrate 180. The photoelectric conversion unit 20 and the signal processing circuit unit 30 are electrically connected to each other via connection wirings provided for each pixel 12. The circuit substrate 180 may further include a vertical scanning circuit unit 40, a readout circuit unit 50, a horizontal scanning circuit unit 60, an output circuit unit 70, and a control pulse generation unit 80.

The photoelectric conversion unit 20 and the signal processing circuit unit 30 of each pixel 12 may be provided on the sensor substrate 110 and the circuit substrate 180 so as to overlap each other in a plan view. The vertical scanning circuit unit 40, the readout circuit unit 50, the horizontal scanning circuit unit 60, the output circuit unit 70, and the control pulse generation unit 80 may be arranged around the pixel unit 10 including the plurality of pixels 12. Here, the term “plan view” refers to a view from a direction perpendicular to the surface of the sensor substrate 110.

By configuring the stacked-type photoelectric conversion device 100, it is possible to increase the degree of integration of elements and achieve higher functionality. In particular, by arranging the photoelectric conversion unit 20 and the signal processing circuit unit 30 on different substrates, the photoelectric conversion elements may be arranged at high density without sacrificing the light receiving area of the photoelectric conversion elements constituting the photoelectric conversion unit 20, and the photon detection efficiency may be improved.

The number of substrates constituting the photoelectric conversion device 100 is not limited to two, and three or more substrates may be stacked to constitute the photoelectric conversion device 100.

In FIG. 4, a diced chip is assumed as the sensor substrate 110 and the circuit substrate 180, but the sensor substrate 110 and the circuit substrate 180 are not limited to chips. For example, each of the sensor substrate 110 and the circuit substrate 180 may be a wafer. In addition, the sensor substrate 110 and the circuit substrate 180 may be stacked in a wafer state and then diced or may be stacked and bonded after being formed into chips.

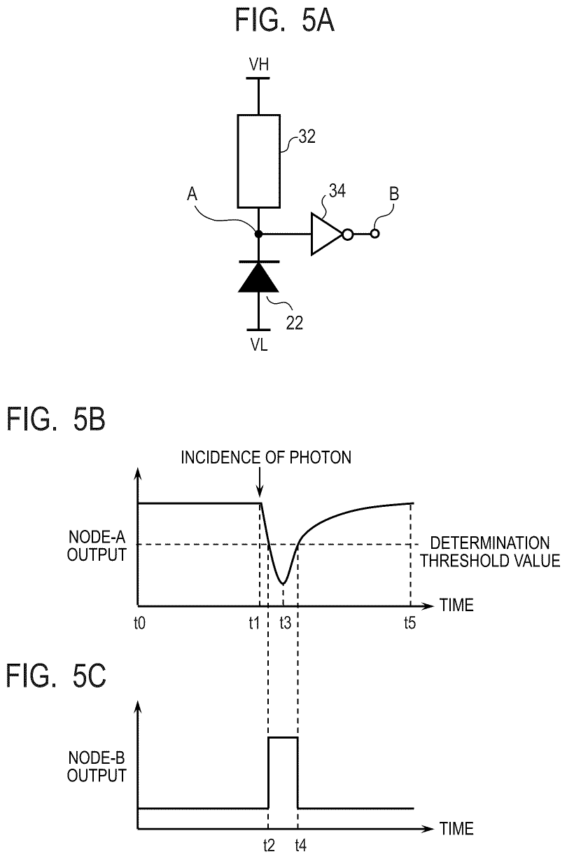

Next, the basic operation of the APD 22, the quenching circuit 32, and the waveform shaping circuit 34 in the photoelectric conversion device according to the present embodiment will be described with reference to FIG. 5A to FIG. 5C. FIG. 5A to FIG. 5C are diagrams illustrating the basic operation of the pixel in the photoelectric conversion device according to the present embodiment. FIG. 5A is a circuit diagram illustrating portions of the APD 22, the quenching circuit 32, and the waveform shaping circuit 34 of the pixel 12. FIG. 5B illustrates a waveform of a signal at an output node (node-A) of the photoelectric conversion unit 20, and FIG. 5C illustrates a waveform of a signal at an output node (node-B) of the waveform shaping circuit 34. Here, in order to simplify the description, it is assumed that the quenching circuit 32 is formed of a resistor and the waveform shaping circuit 34 is formed of an inverter circuit.

At time t0, a reverse bias voltage having a potential difference corresponding to (VH-VL) is applied to the APD 22. Although a reverse bias voltage sufficient to cause avalanche multiplication is applied between the anode and the cathode of the APD 22, carriers serving as seeds of avalanche multiplication do not exist in a state where photons are not incident on the APD 22. Therefore, avalanche multiplication does not occur in the APD 22, and no current flows through the APD 22.

At the subsequent time t1, it is assumed that a photon is incident on the APD 22. When the photon is incident on the APD 22, an electron-hole pair is generated by photoelectric conversion, avalanche multiplication occurs using these carriers as seeds, and an avalanche current flows through the APD 22. When this avalanche current flows through the quenching circuit 32, a voltage drop occurs due to the quenching circuit 32, and the voltage of the node-A starts to drop. When the voltage drop amount of the node-A becomes large and the avalanche multiplication is stopped at time t3, the voltage level of the node-A no longer drops.

When the avalanche multiplication in the APD 22 is stopped, a current that compensates for the voltage drop flows from the node to which the voltage VH is supplied to the node-A via the quenching circuit 32, and the voltage of the node-A gradually increases. Thereafter, at time t5, the node-A is settled to the original voltage level.

The waveform shaping circuit 34 binarizes the signal input from the node-A according to a predetermined determination threshold value (a logic threshold voltage of the inverter circuit) and outputs the signal from the node-B. Specifically, the waveform shaping circuit 34 outputs a low-level signal from the node-B when the voltage level of the node-A exceeds the determination threshold value, and outputs a high-level signal from the node-B when the voltage level of the node-A is equal to or less than the determination threshold value. For example, as illustrated in FIG. 5B, it is assumed that the voltage of the node-A is equal to or lower than the determination threshold value in the period from the time t2 to the time t4. In this case, as illustrated in FIG. 5C, the signal level at the node-B becomes low-level in the period from the time t0 to the time t2 and the period from the time t4 to the time t5 and becomes high-level in the period from the time t2 to the time t4.

Thus, the analog signal input from the node-A is waveform-shaped into a digital signal by the waveform shaping circuit 34. A pulse signal output from the waveform shaping circuit 34 in response to incidence of a photon on the APD 22 is a photon detection signal.

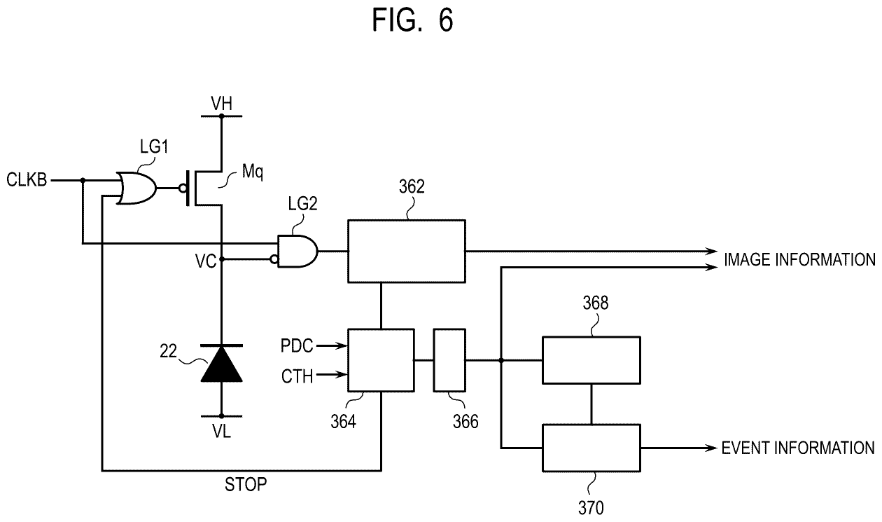

Next, the structure of the pixel 12 of the photoelectric conversion device according to the present embodiment will be described in more detail with reference to FIG. 6. FIG. 6 is a block diagram illustrating a configuration example of a pixel of the photoelectric conversion device according to the present embodiment.

As illustrated in FIG. 6, the pixel 12 of the photoelectric conversion device according to the present embodiment includes an APD 22, a p-channel MOS transistor Mq and an OR circuit LG1 constituting a quenching circuit 32, and an AND circuit LG2 constituting a waveform shaping circuit 34. The counter circuit 36 of the pixel 12 includes a photon detection counter 362 (first counter), an exposure control circuit 364, a time information counter 366 (second counter), a memory 368, a comparison circuit 370, and the pixel 12 further includes a selection circuit 38 (see FIG. 3) (not illustrated).

The anode of the APD 22 is connected to a node to which the voltage VL is supplied. The cathode of the APD 22 is connected to a drain of the p-channel MOS transistor Mq serving as a quenching element. A source of the p-channel MOS transistor Mq is connected to a node to which the voltage VH is supplied. A gate of the p-channel MOS transistor Mq is connected to an output node of the OR circuit LG1. Two input nodes of the OR circuit LG1 receive a clock signal CLKB (inverted signal of the clock signal CLK) from the control pulse generation unit 80 and a control signal STOP that is an output signal of the exposure control circuit 364. Two input nodes of the AND circuit LG2 receive an inverted signal of the cathode voltage VC of the APD 22 and the clock signal CLKB from the control pulse generation unit 80. An output node of the AND circuit LG2 is connected to the photon detection counter 362.

The photon detection counter 362 is connected to the exposure control circuit 364. The exposure control circuit 364 is connected to the time information counter 366. The exposure control circuit 364 receives a determination control signal PDC and a counter threshold value CTH from the control pulse generation unit 80. The counter threshold value CTH may be held in advance by the exposure control circuit 364. The time information counter 366 is connected to the memory 368 and the comparison circuit 370. The comparison circuit 370 is connected to the memory 368.

When light enters the APD 22, charges (electron-hole pairs) are generated by photoelectric conversion. In case where a reverse bias voltage equal to or higher than the breakdown voltage is applied to the APD 22, avalanche multiplication occurs when the generated charge passes through the high electric field region in the element, and an avalanche current is generated.

The cathode of the APD 22 is connected to the node of the voltage VH via the p-channel MOS transistor Mq, and the recharge operation and the quenching operation of the APD 22 may be controlled by the p-channel MOS transistor Mq.

The p-channel MOS transistor Mq is controlled by an output signal of the OR circuit LG1. That is, when the clock signal CLKB and the control signal STOP are at low-level, the p-channel MOS transistor Mq is turned on, and the APD 22 is in a recharged state. As a result, the APD 22 enters a standby state in which avalanche multiplication may be performed after a predetermined period of time. When at least one of the clock signal CLKB and the control signal STOP is at high-level, the p-channel MOS transistor Mq is turned off. When the p-channel MOS transistor Mq is turned off in response to the high-level clock signal CLKB, the APD 22 is in a standby state in which avalanche multiplication may be performed because the p-channel MOS transistor Mq is turned off after the APD 22 is recharged. When the p-channel MOS transistor Mq is turned off in response to the high-level control signal STOP, the APD 22 is not recharged thereafter, and the photon detection signal is not output from the waveform shaping circuit 34. That is, the counting operation in the photon detection counter 362 is stopped.

The inverted signal of the cathode voltage VC of the APD 22 and the clock signal CLKB are input to the AND circuit LG2 constituting the waveform shaping circuit 34. When avalanche multiplication occurs in the APD 22 and the cathode voltage VC falls below the logical threshold voltage of the AND circuit LG2 during a period in which the clock signal CLKB is at high-level, the AND circuit LG2 outputs a high-level signal (photon detection signal) indicating the incidence of a photon.

The photon detection counter 362 counts the photon detection signal output from the AND circuit LG2 and holds the count value as a photon count value. The count period of the photon detection signal and the reset of the photon count value in the photon detection counter 362 may be controlled by the exposure control circuit 364. The photon detection signal may be counted by detecting a rising edge of the photon detection signal or by detecting a falling edge of the photon detection signal.

The exposure control circuit 364 performs a comparison operation of comparing the photon count value of the photon detection counter 362 with a counter threshold value CTH (predetermined threshold value) in response to the determination control signal PDC supplied from the control pulse generation unit 80 at a predetermined timing during the count period. The exposure control circuit 364 controls the p-channel MOS transistor Mq and the time information counter 366 according to the result of the comparison operation. The determination control signal PDC is input to the exposure control circuit 364 a plurality of times (N times) at predetermined timings during the exposure period of one frame.

The time information counter 366 performs a predetermined operation according to the result of the comparison operation in the exposure control circuit 364. Specifically, when the photon count value of the photon detection counter 362 is equal to or less than the counter threshold value CTH, the time information counter 366 increases the time count value by one in accordance with a control signal from the exposure control circuit 364. When the photon count value of the photon detection counter 362 exceeds the counter threshold value CTH, the time information counter 366 latches the time count value at that time in accordance with a control signal from the exposure control circuit 364. The reset of the time count value of the time information counter 366 may be controlled by the exposure control circuit 364.

The comparison circuit 370 compares the time count value of the time information counter 366 with a time count value of the previous frame stored in the memory 368, and outputs information according to the comparison result. Specifically, when the time count value of the time information counter 366 is different from the count value held by the memory 368, the comparison circuit 370 outputs a signal (event information) indicating that an event has been detected. Note that the comparison circuit 370 may output the event information indicating that an event has been detected when the difference between the time count value of the time information counter 366 and the count value held by the memory 368 exceeds a predetermined value.

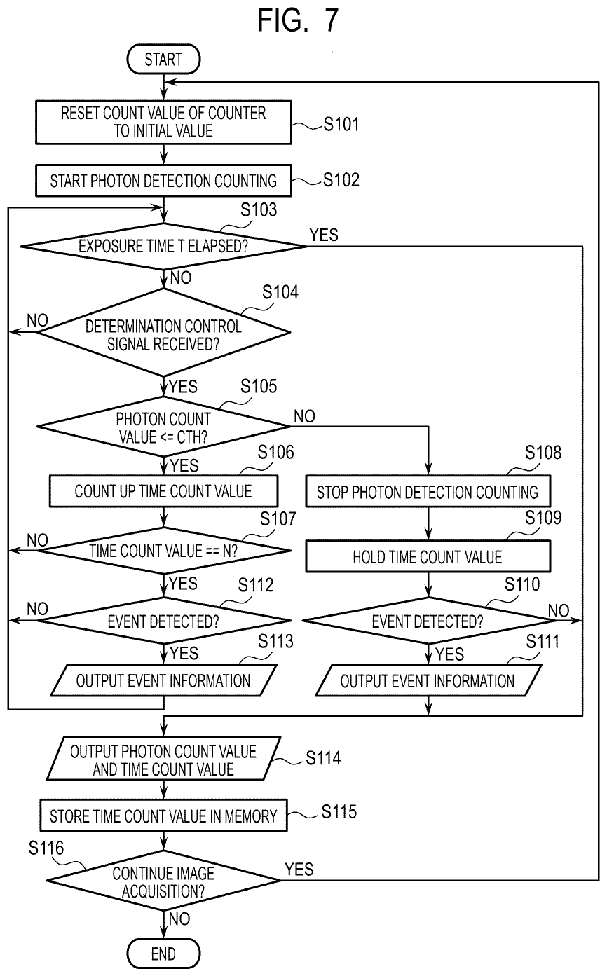

Next, a method of driving the pixel 12 of the photoelectric conversion device according to the present embodiment will be described with reference to FIG. 7. FIG. 7 is a flowchart illustrating a method of driving the pixel of the photoelectric conversion device according to the present embodiment. In the flowchart of FIG. 7, it is assumed that the comparison operation between the photon count value and the counter threshold value CTH in the exposure control circuit 364 is performed N times (N is an integer of 1 or more) during the exposure period of one frame. In the following description, the determination control signal PDC is input three times (N=3) in total at time T1, time T2, and time T3 during the exposure period of one frame. In this specification, the exposure period is a period in which the photon detection counter 362 may be set to a count period in which the photon detection signal may be counted and is a common length (exposure time T) in each frame. The number of times of comparing the photon count value and the counter threshold value CTH during the exposure period is not necessarily three and may be one or more.

The counter threshold value CTH is set in accordance with the input timings of the determination control signal PDC so that the count value of the photon detection counter 362 does not exceed the count saturation value Nsat when the exposure time T is reached. For example, when the comparison operation between the photon count value and the counter threshold value CTH is performed N times, the elapsed time from the start of exposure at the times T1, T2, . . . , and TN may be set to, for example, T/m^{N}, T/m^{N-1}, . . . , and T/m¹, respectively, where T is the maximum exposure time of one frame. In this case, the counter threshold value CTH may be set to Nsat/m with the count saturation value of the photon detection counter 362 as Nsat. Here, m may be an integer of 2 or more but is preferably a power of two. By setting m to a power of two, it is possible to realize the function with a small circuit that only outputs the m-th bit of the photon count value to the exposure control circuit 364 when the photon count value is compared with the counter threshold value CTH.

For example, when the photon count value and the counter threshold value CTH are compared three times, if m is 8 (=2³), the elapsed times from the start of exposure at the times T1, T2, and T3 are T/8³, T/8², and T/8, respectively. The counter threshold value CTH may be set to Nsat/8. For example, when the photon detection counter 362 is an 11-bit counter and the count saturation value (Nsat) is 2048 LSB, the counter threshold value CTH is 256 LSB (=Nsat/8).

When the frame period starts, first, in step S101, the exposure control circuit 364 resets the photon count value of the photon detection counter 362 and the time count value of the time information counter 366 to the initial value (zero).

Next, in step S102, the exposure control circuit 364 controls the control signal STOP to low-level to start the exposure period. When the clock signal CLKB is at low-level, the p-channel MOS transistor Mq is turned on, and the APD 22 is in a recharge state. As a result, the APD 22 enters a standby state in which avalanche multiplication may be performed after a predetermined period of time. When the clock signal CLKB transitions to high-level, the p-channel MOS transistor Mq is turned off, and the recharge state of the APD 22 is canceled. At this time, when a photon enters the APD 22, avalanche multiplication occurs and the cathode voltage VC decreases. Then, the output of the AND circuit LG2 transitions from low-level to high-level, and the count value of the photon detection counter 362 increases by one. When the clock signal CLKB becomes low-level, the p-channel MOS transistor Mq is turned on, and the APD 22 returns to the recharge state. During the exposure period, the above-described operation is repeatedly performed in response to the periodic input of the clock signal CLKB. That is, the photon detection counter 362 counts the pulse signal output corresponding to the period in which the avalanche multiplication occurs among the periods in which the APD 22 is in the standby state.

Next, in step S103, the exposure control circuit 364 determines whether or not the exposure time T has elapsed. As a result of the determination, when the exposure time T has elapsed (“YES” in step S103), the process proceeds to step S114, and when the exposure time T has not elapsed (“NO” in step S103), the process proceeds to step S104. It is assumed here that the elapsed time from the start of the exposure period is before the time T1, and the process proceeds to step S104.

Next, in step S104, the exposure control circuit 364 determines whether or not the determination control signal PDC has been received. As a result of the determination, when the determination control signal PDC is received (“YES” in step S104), the process proceeds to step S105, and when the determination control signal PDC is not received (“NO” in step S104), the process returns to step S103. It is assumed here that the determination control signal PDC is received when the time T1 elapses, and the process proceeds to step S105.

Next, in step S105, the exposure control circuit 364 determines whether or not the photon count value of the photon detection counter 362 exceeds the counter threshold value CTH. As a result of the determination, when the photon count value is equal to or less than the counter threshold value CTH (“YES” in step S105), the process proceeds to step S106, and when the photon count value exceeds the counter threshold value CTH (“NO”in step S105), the process proceeds to step S108.

When it is determined in step S105 that the photon count value is equal to or less than the counter threshold value CTH, the exposure control circuit 364 counts up (increases by one) the time count value of the time information counter 366 in step S106. For example, when the time information counter 366 has a 2-bit configuration, the time count value changes from “00” to “01”. After step S106, the process proceeds to step S107.

In step S107, it is determined whether or not the time count value has reached the maximum number of times (N) that the determination control signal PDC is input during the exposure period of one frame. As a result of the determination, when the time count value has reached N (“YES” in step S107), the process proceeds to step S112, and when the time count value is less than N (“NO”in step S107), the process returns to step S103.

Although the time count value is used to specify the last determination control signal PDC input during the exposure period (exposure time T) of one frame in FIG. 7, the method of specifying the last determination control signal PDC is not limited thereto. For example, a counter for counting the elapsed time from the start of the exposure period may be provided, and the determination control signal PDC input when the count value of the counter is equal to or exceeds a predetermined value may be specified as the last determination control signal PDC.

When it is determined in step S105 that the photon count value exceeds the counter threshold value CTH, the exposure control circuit 364 controls the control signal STOP from low-level to high-level in step S108. Accordingly, the p-channel MOS transistor Mq is fixed to the off state irrespective of the clock signal CLKB, and the recharge operation of the APD 22 is stopped, that is, the exposure stop state is set. After step S108, the process proceeds to step S109.

In step S109, the exposure control circuit 364 latches the time information counter 366 with the time count value at that time. When the photon count value exceeds the counter threshold value CTH, the time count value is not counted up, and thus the time count value (“00”) at that time is held in the time information counter 366. After step S109, the process proceeds to step S110.

In step S110, the comparison circuit 370 compares the count value of the previous frame held in the memory 368 with the time count value (“00”) held by the time information counter 366. As a result of the comparison, when the time count value held by the time information counter 366 is different from the count value held in the memory 368 (“YES” in step S110), it is determined that an event has been detected, and the process proceeds to step S111. In step S111, the comparison circuit 370 outputs information (event information) indicating that an event has been detected to the output line 16 via the selection circuit 38. In this case, the event information may be output after the time T1 before the exposure time T elapses. After step S111, the process proceeds to step S114. As a result of the comparison, when the time count value held by the time information counter 366 is equal to the count value held in the memory 368 (“NO” in step S110), it is determined that no event has been detected, and the process proceeds to step S114.

When it is determined in step S107 that the time count value is less than N, the process returns to step S103, and the same process as described above is repeated. In steps S103 and S104, the photon detection counting operation is continued until the second determination control signal PDC is received at the time T2.

When the time T2 elapses and the second determination control signal PDC is received, the process proceeds to step S105. The exposure control circuit 364 determines whether or not the photon count value of the photon detection counter 362 exceeds the counter threshold value CTH. As a result of the determination, when the photon count value is equal to or less than the counter threshold value CTH (“YES” in step S105), the process proceeds to step S106, and when the photon count value exceeds the counter threshold value CTH (“NO”in step S105), the process proceeds to step S108.

When it is determined in step S105 that the photon count value is equal to or less than the counter threshold value CTH, the exposure control circuit 364 increases the time count value of the time information counter 366 by one in step S106. For example, when the time information counter 366 has a 2-bit configuration, the time count value changes from “01”to “10”. After step S106, the process proceeds to step S107.

In step S107, it is determined whether or not the time count value has reached the maximum number of times (N) that the determination control signal PDC is input during the exposure period of one frame. As a result of the determination, when the time count value has reached N (“YES” in step S107), the process proceeds to step S112, and when the time count value is less than N (“NO”in step S107), the process returns to step S103.

When it is determined in step S105 that the photon count value exceeds the counter threshold value CTH, the exposure control circuit 364 controls the control signal STOP from low-level to high-level in step S108. Accordingly, the p-channel MOS transistor Mq is fixed to the off state irrespective of the clock signal CLKB, and the recharge operation of the APD 22 is stopped, that is, the exposure stop state is set. After step S108, the process proceeds to step S109.

In step S109, the exposure control circuit 364 latches the time information counter 366 with the time count value at that time. When the photon count value exceeds the counter threshold value CTH, the time count value is not counted up, and thus the time count value (“01”) at that time is held in the time information counter 366. After step S109, the event detection determination process is performed in step S110 in the same manner as described above. When an event is detected in step S110, event information is output in step S111. In this case, the event information may be output after the time T2 before the exposure time T elapses. After step S110 or step S111, the process proceeds to step S114.

When it is determined in step S107 that the time count value is less than N, the process returns to step S103, and the same process as described above is repeated. In steps S103 and S104, the photon detection counting operation is continued until the third determination control signal PDC is received at the time T3.

When the time T3 elapses and the third determination control signal PDC is received, the process proceeds to step S105. The exposure control circuit 364 determines whether or not the photon count value of the photon detection counter 362 exceeds the counter threshold value CTH. As a result of the determination, when the photon count value is equal to or less than the counter threshold value CTH (“YES” in step S105), the process proceeds to step S106, and when the photon count value exceeds the counter threshold value CTH (“NO”in step S105), the process proceeds to step S108.

When it is determined in step S105 that the photon count value is equal to or less than the counter threshold value CTH, the exposure control circuit 364 increases the time count value of the time information counter 366 by one in step S106. For example, when the time information counter 366 has a 2-bit configuration, the time count value changes from “10”to “11”. After step S106, the process proceeds to step S107.

In step S107, it is determined whether or not the time count value has reached the maximum number of times (N) that the determination control signal PDC is input during the exposure period of one frame. As a result of the determination, when the time count value has reached N (“YES” in step S107), the process proceeds to step S112, and when the time count value is less than N (“NO” in step S107), the process returns to step S103. Here, since the number of times the determination control signal PDC is input during the exposure period of one frame is set to three times (N=3), the process proceeds to step S112.

In step S112, an event detection determination process similar to that in step S110 is performed. When an event is detected in step S112, an event information output process similar to that in step S111 is performed in step S113. In this case, the event information may be output after the time T3 before the exposure time T elapses. After step S113, the process returns to step S103.

After step S112 or step S113, the processes of steps S103 and S104 are repeatedly performed until the exposure time T elapses, and the photon detection counting operation is continued. After that, when the exposure time T elapses, the process proceeds to step S114.

As described above, when the photon count value exceeds the counter threshold value CTH at the time T1, the process proceeds to step S114 with a state where the time count value “00” is held in the time information counter. When the photon count value exceeds the counter threshold value CTH at the time T2, the process proceeds to step S114 with a state where the time count value “01” is held in the time information counter. When the photon count value exceeds the counter threshold value CTH at the time T3, the process proceeds to step S114 with a state where the time count value “10” is held in the time information counter.

When the exposure time T has elapsed without the photon count value exceeding the counter threshold value CTH at the time T3, the process proceeds to step S114 with a state where the time count value “11”is held in the time information counter.

Next, in step S114, the vertical scanning circuit unit 40 drives the selection circuit 38 and outputs the photon count value held in the photon detection counter 362 and the time count value held in the time information counter 366 to the output line 16 via the selection circuit 38.

Next, in step S115, the exposure control circuit 364 stores the time count value held in the time information counter 366 in the memory 368. The time count value stored in the memory 368 is used for the determination processing of event detection in step S110 or step S112 of the next frame.

Next, in step S116, the control pulse generation unit 80 determines whether to continue image acquisition. As a result of the determination, when the image acquisition is continued (“YES” in step S116), the process returns to step S101, and the process of the next frame is executed. As a result of the determination, when the image acquisition is not continued (“NO”in step S116), the imaging process is ended.

As described above, in the present embodiment, the comparison operation of comparing the photon count value with the predetermined counter threshold value CTH is performed a plurality of times during the exposure period of one frame. Accordingly, in each pixel 12, an appropriate count period corresponding to the photon count value may be selected from a plurality of count periods having different lengths, and image information may be acquired without increasing the number of bits of the photon detection counter 362.

The signal output from each pixel 12 includes count information (photon count value) and exposure time information (time count value). By using these pieces of information and correcting the photon count value according to the exposure time, an HDR image may be acquired. For example, when the time count value is “00”, it indicates that the counting operation of the photon detection counter 362 has been performed until the time T1. In this case, the photon count value corresponding to the exposure time T may be acquired by multiplying the photon count value acquired from the photon detection counter 362 by (T/T1).

In the present embodiment, the exposure time information (time count value) in each pixel 12 is compared with the exposure time information in the immediately preceding frame, and information is output as the event information when the two pieces of compared exposure time information indicate different values. As a result, when a steep luminance change occurs, it is possible to output this as event information for each pixel 12.

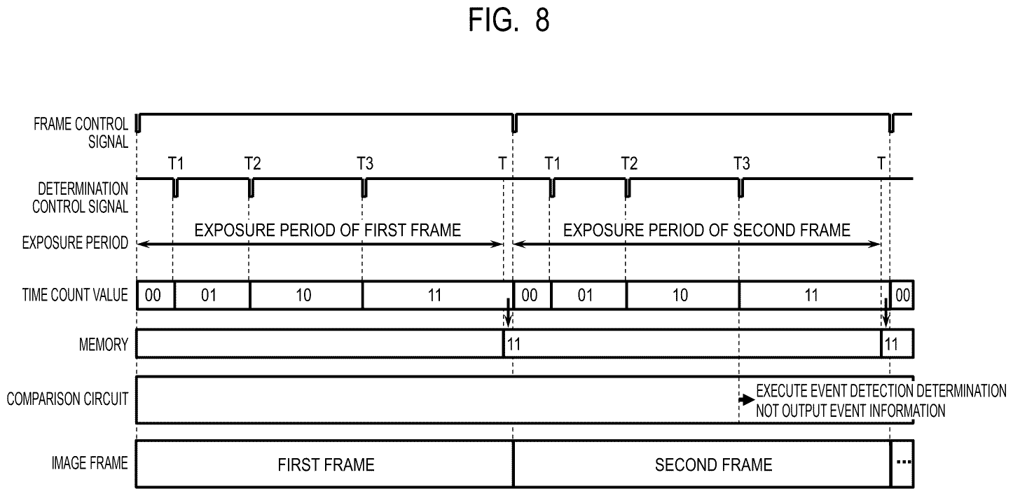

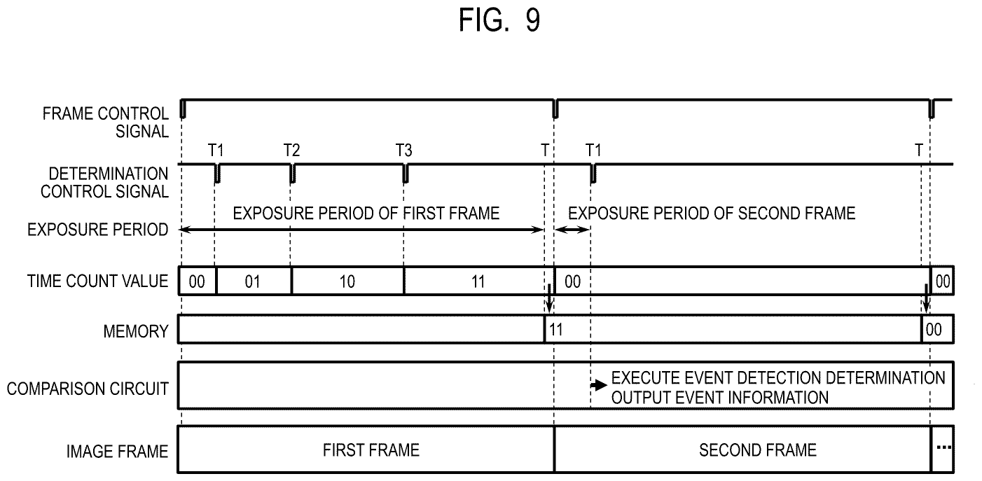

Next, an operation example of the pixel 12 of the photoelectric conversion device according to the present embodiment will be described with reference to FIG. 8 and FIG. 9. FIG. 8 and FIG. 9 are timing charts illustrating operation examples of the pixel of the photoelectric conversion device according to the present embodiment. FIG. 8 and FIG. 9 illustrate operations of the time information counter 366, the memory 368, and the comparison circuit 370 in two consecutive frames (first frame and second frame). Each frame starts in response to a frame control signal and acquires an HDR image at the end of each frame. The photon count value and the counter threshold value CTH are compared with each other at timings when the times T1, T2, and T3 have elapsed from the start of exposure in accordance with the determination control signal PDC.

FIG. 8 illustrates an operation example in a case where an object has low luminance in the first frame and the second frame, and a steep luminance change does not occur between the first frame and the second frame. When the first frame is started according to the frame control signal, the photon count value and the time count value are reset, and the exposure period of the first frame is started. When the object has low brightness, the photon count value becomes equal to or less than the counter threshold value CTH at each of the times T1, T2, and T3, and the time count value becomes “11” after the time T3. As a result, the count value “11” is stored in the memory 368. When the second frame is started according to the frame control signal, the photon count value and the time count value are reset, and the exposure period of the second frame is started. When the object has low brightness, the photon count value becomes equal to or less than the counter threshold value CTH at each of the times T1, T2, and T3, and the time count value becomes “11” after the time T3. The event detection determination is performed by comparing the information stored in the memory 368 with the time count value immediately after the time T3 at which the time information in the second frame is determined. In this operation example, since both of the information stored in the memory 368 and the time count value are “11” and there is no difference, it is determined that there is no event detection, and the event information is not output.

FIG. 9 illustrates an operation example in a case where an object has a low luminance in the first frame, the object has a high luminance in the second frame, and a steep luminance change occurs between the first frame and the second frame. When the first frame is started according to the frame control signal, the photon count value and the time count value are reset, and the exposure period of the first frame is started. When the object has low brightness, the photon count value becomes equal to or less than the counter threshold value CTH at each of the times T1, T2, and T3, and the time count value becomes “11” after the time T3. As a result, the count value “11” is stored in the memory 368. When the second frame is started according to the frame control signal, the photon count value and the time count value are reset, and the exposure period of the second frame is started. When the object has high brightness, the photon count value exceeds the counter threshold value CTH at, e.g., the time T1 and the control signal STOP is output, whereby the counting operation of the photon detection counter 362 ends at the time T1. The time count value is held at “00” without being counted up. The event determination is performed by comparing the information stored in the memory 368 with the time count value immediately after the time T1 at which the time information in the second frame is determined. In this operation example, since the time count value is “00” while the information stored in the memory 368 is “11”, it is determined that an event has been detected, and event information is output.

As described above, in the present embodiment, the count value of the photon detection counter 362 is compared with the counter threshold value CTH a plurality of times during the exposure period of one frame. The time information counter 366 is provided to count up every time it is determined that the count value of the photon detection counter 362 is equal to or less than the counter threshold value CTH. Then, the event information is output according to the result of comparison between the count value of the time information counter 366 in the first frame and the count value of the time information counter 366 in the second frame before the first frame.

Therefore, an appropriate count period corresponding to the photon count value may be selected from among a plurality of count periods having different lengths, and image information may be acquired without increasing the number of bits of the photon detection counter 362. In addition, since the time count value is compared with the time count value in the previous frame, and the event information is output when these count values are different, the event information may be output when a steep luminance change occurs.

Further, by comparing the time count values, the number of configuration bits of the memory 368 may be reduced and the circuit configuration of the comparison circuit 370 may be simplified as compared with the case of comparing the photon count values. This makes it possible to reduce the circuit area and power consumption.

As described above, according to the present embodiment, it is possible to realize a photoelectric conversion device capable of acquiring a high dynamic range image and detecting an event while suppressing power consumption.

### Second Embodiment

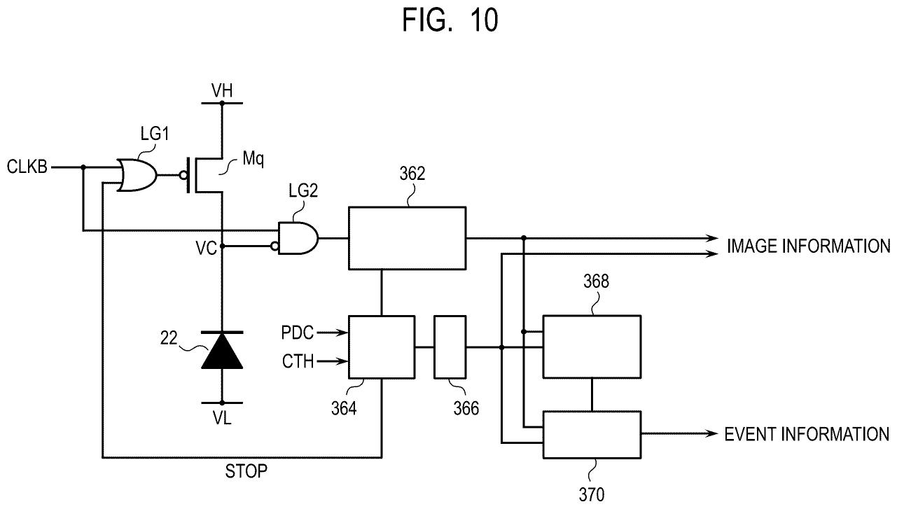

A photoelectric conversion device and a method of driving the same according to a second embodiment will be described with reference to FIG. 10. The same components as those of the photoelectric conversion device according to the first embodiment are denoted by the same reference numerals, and description thereof will be omitted or simplified. FIG. 10 is a block diagram illustrating a configuration example of a pixel of the photoelectric conversion device according to the present embodiment.

The photoelectric conversion device according to the present embodiment is the same as the photoelectric conversion device according to the first embodiment except that the configuration of the pixel 12 is different. In the present embodiment, differences between the pixel 12 of the photoelectric conversion device according to the present embodiment and the pixel 12 of the photoelectric conversion device according to the first embodiment will be mainly described, and description of portions similar to those of the first embodiment will be appropriately omitted.

In the pixel 12 of the photoelectric conversion device according to the present embodiment, as illustrated in FIG. 10, the photon detection counter 362 is connected to the memory 368 and the comparison circuit 370 in addition to the exposure control circuit 364. The high-order bit information of the photon count value is supplied from the photon detection counter 362 to the memory 368 and the comparison circuit 370. Other points are the same as those of the pixel 12 of the first embodiment.

When the exposure period of one frame ends, in step S115, the photon detection counter 362 stores the high-order bit information of the photon count value and the time count value in the memory 368. In the event detection determination in step S110 or step S112 of the next frame, the time count value of the time information counter 366 and the high-order bit information of the photon count value in the present frame is compared with the count value and the information stored in the memory 368.

First, the comparison circuit 370 compares the time count value held by the time information counter 366 with the count value stored in the memory 368. As a result of the comparison, when these values are different, it is determined that the event is detected, and when the event detection determination is made in step S110, the process proceeds to step S111, and when the event detection determination is made in step S112, the process proceeds to step S113.

As a result of the comparison, when the time count value held by the time information counter 366 and the count value stored in the memory 368 are the same, the comparison circuit 370 compares the high-order bit information of the photon count value with the information stored in the memory 368.

As a result of comparison between the high-order bit information of the photon count value and the information stored in the memory 368, it is determined that no event is detected when these pieces of information are the same. When the event detection determination is made in step S110, the process proceeds to step S114, and when the event detection determination is made in step S112, the process proceeds to step S103.

As a result of the comparison between the high-order bit information of the photon count value and the information stored in the memory 368, it is determined that the event is detected when the high-order bit information of the photon count value and the information stored in the memory 368 are different from each other. When the event detection determination is made in step S110, the process proceeds to step S111, and when the event detection determination is made in step S112, the process proceeds to step S113.

In this way, by using the high-order bit information of the photon count value in addition to the time count value for the event detection determination, the sensitivity of the event detection may be increased, and the event detection determination may be performed with higher accuracy. Further, by comparing the information of the high-order bits of the photon count value, the number of bits of the memory 368 may be reduced and the circuit configuration of the comparison circuit 370 may be simplified as compared with the case of comparing all the bits of the photon count value. This makes it possible to reduce the circuit area and power consumption.

The high-order bit information of the photon detection counter 362 used for comparison is not particularly limited. For example, when the photon detection counter 362 is configured by an 11-bit counter, it may be configured to compare the information of the upper three bits from the eighth bit to the tenth bit. The number of upper bits used for comparison may be appropriately set according to the accuracy required for event detection.

As described above, according to the present embodiment, it is possible to realize a photoelectric conversion device capable of acquiring a high dynamic range image and detecting an event while suppressing power consumption.

### Third Embodiment

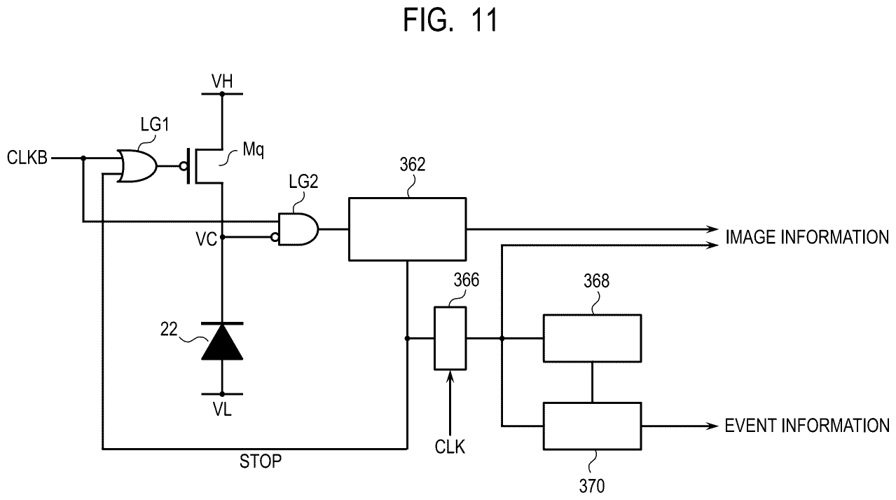

A photoelectric conversion device and a method of driving the same according to a third embodiment will be described with reference to FIG. 11. The same components as those of the photoelectric conversion device according to the first or second embodiment are denoted by the same reference numerals, and description thereof will be omitted or simplified. FIG. 11 is a block diagram illustrating a configuration example of a pixel of the photoelectric conversion device according to the present embodiment.

The photoelectric conversion device according to the present embodiment is the same as the photoelectric conversion device according to the first embodiment except that the configuration of the pixel 12 is different. In the present embodiment, differences between the pixel 12 of the photoelectric conversion device according to the present embodiment and the pixel 12 of the photoelectric conversion device according to the first embodiment will be mainly described, and description of portions similar to those of the first embodiment will be appropriately omitted.

As illustrated in FIG. 11, the pixel 12 of the photoelectric conversion device according to the present embodiment does not include the exposure control circuit 364 and is configured such that a signal output from the photon detection counter 362 is supplied to the OR circuit LG1 and the time information counter 366. The clock signal CLK is supplied to the time information counter 366 from the control pulse generation unit 80 or an external device. Other points are the same as those of the pixel 12 of the first embodiment. The period of the clock signal CLK supplied to the time information counter 366 may be the same as or different from the period of the clock signal CLKB supplied to the OR circuit LG1.

In the present embodiment, event detection is performed by comparing time information in which the photon detection counter 362 reaches the count upper limit value (=Nsat−1) between frames. The photon detection counter 362 transmits a signal (upper limit arrival notification signal) indicating that the count value has reached the count upper limit value during the exposure period to the time information counter 366. The upper limit arrival notification signal also serves as the above-described control signal STOP and is a signal that transitions from low-level to high-level in response to the photon count value reaching the count upper limit value. The time information counter 366 starts counting the clock signal CLK in synchronization with the start of the exposure period and stops counting the clock signal CLK in response to the reception of the upper limit arrival notification signal. The count value when the counting is stopped in response to the upper limit arrival notification signal is the time count value in the present embodiment.

When the exposure period of a certain frame ends, the time count value of the time information counter 366 is stored in the memory 368 as in step S115 of FIG. 7. In the next frame, similarly to step S110 or step S112 of FIG. 7, the event detection determination is performed by comparing the time count value when the time information counter 366 receives the upper limit arrival notification signal with the count value stored in the memory 368.

The event detection determination may be performed based on whether the time count value at the time of receiving the upper limit arrival notification signal is the same as the count value stored in the memory 368. Alternatively, whether or not the difference between the time count value at the time of receiving the upper limit arrival notification signal and the count value stored in the memory 368 exceeds a predetermined event determination threshold value may be used as a reference. The criterion of the event detection determination may be appropriately set according to the accuracy required for the event detection or the like.

As described above, according to the present embodiment, it is possible to realize a photoelectric conversion device capable of acquiring a high dynamic range image and detecting an event while suppressing power consumption.

### Fourth Embodiment

A photoelectric conversion device and a method of driving the same according to a fourth embodiment will be described. The same components as those of the photoelectric conversion devices according to the first to third embodiments are denoted by the same reference numerals, and description thereof will be omitted or simplified.

Although the first to third embodiments have been described on the assumption that each of the plurality of pixels 12 constituting the pixel unit 10 has an event detection function, it is not always necessary to perform event detection in all the pixels 12 constituting the pixel unit 10.

For example, the plurality of pixels 12 constituting the pixel unit 10 may be divided into a plurality of pixel blocks each including at least one pixel 12, and event detection may be performed in a part of the plurality of pixel blocks. In this case, for example, the pixels 12 of the pixel block in which the event detection is not performed may be configured to output only the image information by turning off the power of the comparison circuit 370. Note that the method of outputting only the image information from the pixel 12 is not limited to the method of turning off the power of the comparison circuit 370, and an arbitrary method may be applied.

The pixel block may be arbitrarily set. For example, the pixel unit 10 may be divided into a plurality of pixel blocks in a grid pattern, or the pixel unit 10 may be divided into a plurality of pixel blocks in units of rows or columns. The number of pixels for performing the event detection operation may also be arbitrarily set. The division mode of the pixel unit 10 and the pixel block for performing event detection may be configured to be changeable.

In addition, some of the pixels 12 included in the pixel unit 10 may have an event detection function. In this case, the memory 368 and the comparison circuit 370 may be omitted in the pixel 12 in which the event detection function is unnecessary. The pixel having an event detection function does not necessarily output image information and may be configured to output only event information.

As described above, according to the present embodiment, it is possible to realize a photoelectric conversion device capable of acquiring a high dynamic range image and detecting an event while suppressing power consumption.

### Fifth Embodiment

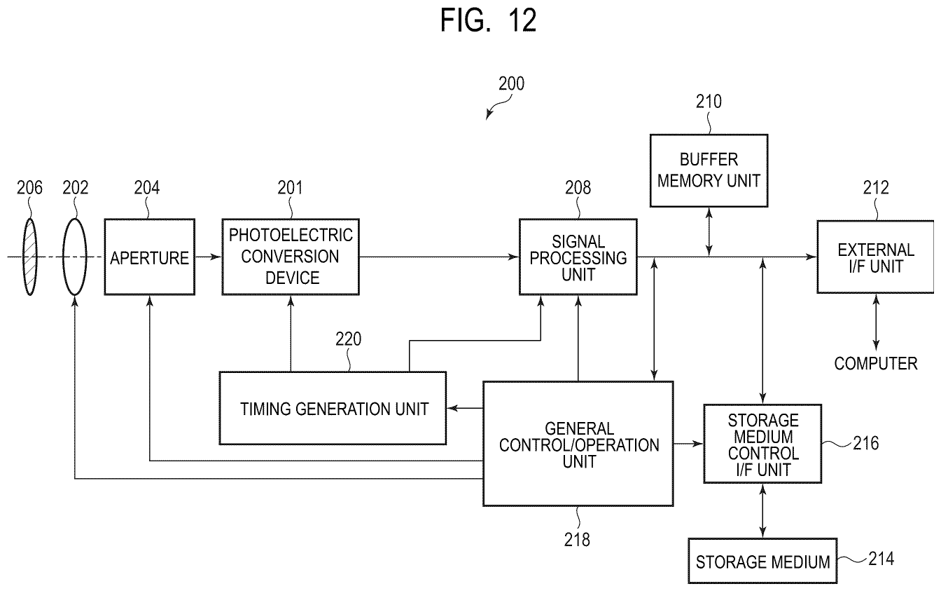

A photodetection system according to a fifth embodiment will be described with reference to FIG. 12. FIG. 12 is a block diagram illustrating a schematic configuration of a photodetection system according to the present embodiment. In the present embodiment, a photodetection sensor to which the photoelectric conversion device 100 according to any one of the first to fourth embodiments is applied will be described.

The photoelectric conversion device 100 described in the first to fourth embodiments may be applied to various photodetection systems. Examples of applicable photodetection systems include imaging systems such as digital still cameras, digital camcorders, surveillance cameras, copying machines, facsimiles, mobile phones, on-vehicle cameras, observation satellites, and the like. A camera module including an optical system such as a lens and an imaging device is also included in the photodetection system. FIG. 12 exemplifies a block diagram of a digital still camera as one of these.

The photodetection system 200 illustrated in FIG. 12 includes a photoelectric conversion device 201, a lens 202 that forms an optical image of an object on the photoelectric conversion device 201, an aperture 204 that changes the amount of light passing through the lens 202, and a barrier 206 that protects the lens 202. The lens 202 and the aperture 204 constitute an optical system that focuses light onto the photoelectric conversion device 201. The photoelectric conversion device 201 is the photoelectric conversion device 100 described in any one of the first to fourth embodiments and converts the optical image formed by the lens 202 into image data.

The photodetection system 200 further includes a signal processing unit 208 that processes a signal output from the photoelectric conversion device 201. The signal processing unit 208 generates image data from the digital signal output from the photoelectric conversion device 201. Further, the signal processing unit 208 performs various corrections and compressions as necessary and outputs the processed image data. The photoelectric conversion device 201 may include an AD conversion unit that generates a digital signal to be processed by the signal processing unit 208. The AD conversion unit may be formed on a semiconductor layer (semiconductor substrate) in which the photoelectric conversion element of the photoelectric conversion device 201 is formed or may be formed on a semiconductor layer different from the semiconductor layer in which the photoelectric conversion element of the photoelectric conversion device 201 is formed. The signal processing unit 208 may be formed on the same semiconductor layer as the photoelectric conversion device 201.

The photodetection system 200 further includes a buffer memory unit 210 for temporarily storing image data, and an external interface unit (external I/F unit) 212 for communicating with an external computer or the like. Further, the photodetection system 200 includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photodetection system 200 or may be detachable. Communication between the storage medium control I/F unit 216 and the storage medium 214 and communication from the external I/F unit 212 may be performed wirelessly.

The photodetection system 200 further includes a general control/operation unit 218 that performs various calculations and controls the entire digital still camera, and a timing generation unit 220 that outputs various timing signals to the photoelectric conversion device 201 and the signal processing unit 208. Here, the timing signal or the like may be input from the outside, and the photodetection system 200 may include at least the photoelectric conversion device 201 and the signal processing unit 208 that processes the output signal output from the photoelectric conversion device 201. The timing generation unit 220 may be mounted on the photoelectric conversion device 201. Further, the general control/operation unit 218 and the timing generation unit 220 may be configured to perform a part or all of the control functions of the photoelectric conversion device 201.

The photoelectric conversion device 201 outputs an imaging signal to the signal processing unit 208. The signal processing unit 208 performs predetermined signal processing on the imaging signal output from the photoelectric conversion device 201 and outputs image data. The signal processing unit 208 generates an image using the imaging signal. The signal processing unit 208 may be configured to perform distance measurement calculation on the signal output from the photoelectric conversion device 201.

As described above, according to the present embodiment, by configuring the photodetection system using the photoelectric conversion devices according to any one of the first to fourth embodiments, it is possible to realize the photodetection system capable of acquiring a higher quality image.

### Sixth Embodiment

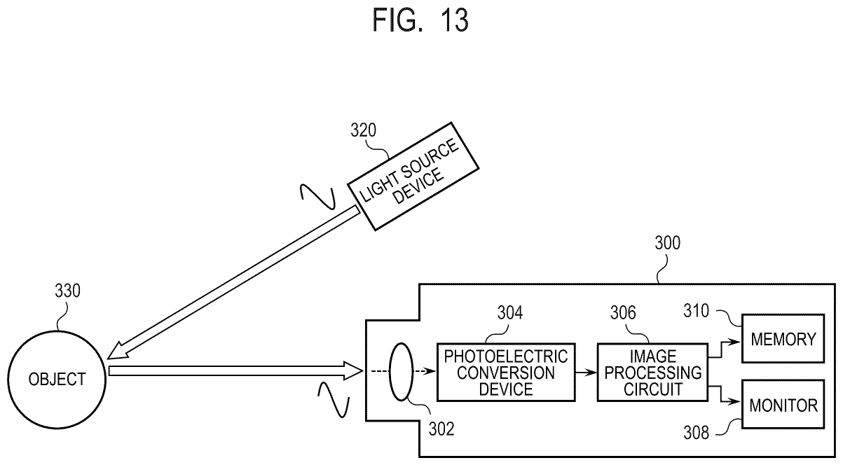

A range image sensor according to a sixth embodiment will be described with reference to FIG. 13. FIG. 13 is a block diagram illustrating a schematic configuration of a range image sensor according to the present embodiment. In the present embodiment, a range image sensor will be described as an example of a photodetection system to which the photoelectric conversion device 100 according to any one of the first to fourth embodiments is applied.

As illustrated in FIG. 13, the range image sensor 300 according to the present embodiment may include an optical system 302, a photoelectric conversion device 304, an image processing circuit 306, a monitor 308, and a memory 310. The range image sensor 300 receives light (modulated light or pulsed light) emitted from the light source device 320 toward an object 330 and reflected on the surface of the object 330 and acquires a distance image corresponding to the distance to the object 330.

The optical system 302 includes one or a plurality of lenses and has a function of forming an image of image light (incident light) from the object 330 on a light receiving surface (sensor unit) of the photoelectric conversion device 304.

The photoelectric conversion device 304 is the photoelectric conversion device 100 described in any one of the first to fourth embodiments and has a function of generating a distance signal indicating a distance to the object 330 based on image light from the object 330 and supplying the generated distance signal to the image processing circuit 306.

The image processing circuit 306 has a function of performing image processing for constructing a distance image based on the distance signal supplied from the photoelectric conversion device 304.

The monitor 308 has a function of displaying a distance image (image data) obtained by image processing in the image processing circuit 306. The memory 310 has a function of storing (recording) a distance image (image data) obtained by image processing in the image processing circuit 306.

As described above, according to the present embodiment, by configuring the range image sensor using the photoelectric conversion devices according to any one of the first to fourth embodiments, it is possible to realize a range image sensor capable of acquiring a range image including more accurate range information in conjunction with improvement in characteristics of the pixels 12.

### Seventh Embodiment

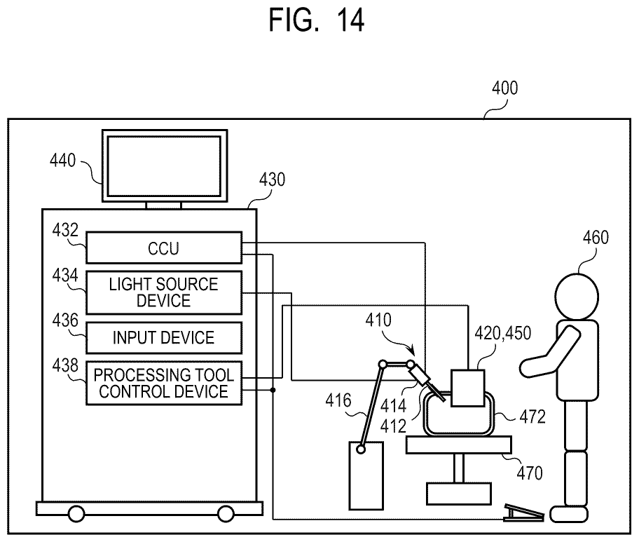

An endoscopic surgical system according to a seventh embodiment will be described with reference to FIG. 14.

FIG. 14 is a schematic diagram illustrating a configuration example of an endoscopic surgical system according to the present embodiment. In the present embodiment, an endoscopic surgical system will be described as an example of a photodetection system to which the photoelectric conversion device 100 according to any one of the first to fourth embodiments is applied.

FIG. 14 illustrates a state in which an operator (surgeon) 460 performs surgery on a patient 472 on a patient bed 470 using an endoscopic surgical system 400.

As illustrated in FIG. 14, the endoscopic surgical system 400 according to the present embodiment may include an endoscope 410, a surgical tool 420, and a cart 430 on which various equipment for endoscopic surgery are mounted. A camera control unit (CCU) 432, a light source device 434, an input device 436, a processing tool control device 438, a display device 440, and the like may be mounted on the cart 430.

The endoscope 410 includes a lens barrel 412 in which an area of a predetermined length from the tip is inserted into a body cavity of the patient 472, and a camera head 414 connected to the base end of the lens barrel 412. Although FIG. 14 illustrates an endoscope 410 configured as a so-called rigid mirror having a rigid lens barrel 412, the endoscope 410 may be configured as a so-called flexible mirror having a flexible lens barrel. The endoscope 410 is held in a movable state by an arm 416.

The tip of the lens barrel 412 is provided with an opening into which an objective lens is fitted. A light source device 434 is connected to the endoscope 410, and light generated by the light source device 434 is guided to the tip of the lens barrel 412 by a light guide extended inside the lens barrel and is irradiated toward an observation target in the body cavity of the patient 472 through the objective lens. Note that the endoscope 410 may be a direct-viewing mirror, an oblique-viewing mirror, or a side-viewing mirror.

An optical system and a photoelectric conversion device (not illustrated) are provided inside the camera head 414, and reflected light (observation light) from the observation target is focused on the photoelectric conversion device by the optical system.

The photoelectric conversion device photoelectrically converts the observation light and generates an electrical signal corresponding to the observation light, that is, an image signal corresponding to the observation image. As the photoelectric conversion device, the photoelectric conversion device 100 described in any one of the first to fourth embodiments may be used. The image signal is transmitted to the CCU 432 as RAW data.

The CCU 432 may be configured by a central processing unit (CPU), a graphics processing unit (GPU), or the like, and integrally controls operations of the endoscope 410 and the display device 440. Further, the CCU 432 receives an image signal from the camera head 414 and performs various types of image processing for displaying an image based on the image signal, such as development processing (demosaic processing).

The display device 440 displays an image based on the image signal subjected to the image processing by the CCU 432 under the control of the CCU 432.

The light source device 434 may be configured by, for example, a light source such as a light emitting diode (LED), and supplies irradiation light to the endoscope 410 when photographing a surgical part or the like.

The input device 436 is an input interface to the endoscopic surgical system 400.

The user may input various kinds of information and input instructions to the endoscopic surgical system 400 via the input device 436.

The processing tool control device 438 controls the driving of the energy processing tool 450 for tissue ablation, incision, blood vessel sealing, or the like.

The light source device 434 that supplies irradiation light to the endoscope 410 when imaging the surgical part may be configured by, for example, a white light source configured by an LED, a laser light source, or a combination thereof. When the white light source is configured by a combination of the RGB laser light sources, since the output intensity and the output timing of each color (each wavelength) may be controlled with high accuracy, the white balance of the captured image may be adjusted in the light source device 434. In addition, in this case, it is also possible to capture an image corresponding to each of RGB in a time division manner by irradiating the observation target with laser light from each of the RGB laser light sources in a time division manner and controlling driving of the imaging element of the camera head 414 in synchronization with the irradiation timing. According to this method, a color image may be obtained without providing a color filter in the image sensor.

Further, the driving of the light source device 434 may be controlled so as to change the intensity of light to be output every predetermined time. By controlling the driving of the image sensor of the camera head 414 in synchronization with the timing of the change of the intensity of the light to acquire an image in a time-division manner and compositing the image, it is possible to generate an image having a high dynamic range free from so-called blacked up shadows and blown out highlights.

The light source device 434 may be configured to be capable of supplying light in a predetermined wavelength band corresponding to special light observation. In the special light observation, for example, wavelength dependency of absorption of light in body tissue is utilized. Specifically, a predetermined tissue such as a blood vessel in the superficial layer of a mucous membrane is photographed with high contrast by irradiating light in a narrow band as compared with irradiation light (that is, white light) at the time of normal observation. Alternatively, in the special light observation, fluorescence observation in which an image is obtained by fluorescence generated by irradiation with excitation light may be performed. In the fluorescence observation, a body tissue is irradiated with excitation light to observe fluorescence from the body tissue, or a body tissue is locally injected with a reagent such as indocyanine green (ICG), and the body tissue is irradiated with excitation light corresponding to a fluorescence wavelength of the reagent to obtain a fluorescence image. The light source device 434 may be configured to be capable of supplying narrowband light and/or excitation light corresponding to such special light observation.

As described above, according to the present embodiment, by configuring the endoscopic surgical system using the photoelectric conversion devices according to any one of the first to fourth embodiments, it is possible to realize an endoscopic surgical system capable of acquiring a better quality image.

### Eighth Embodiment

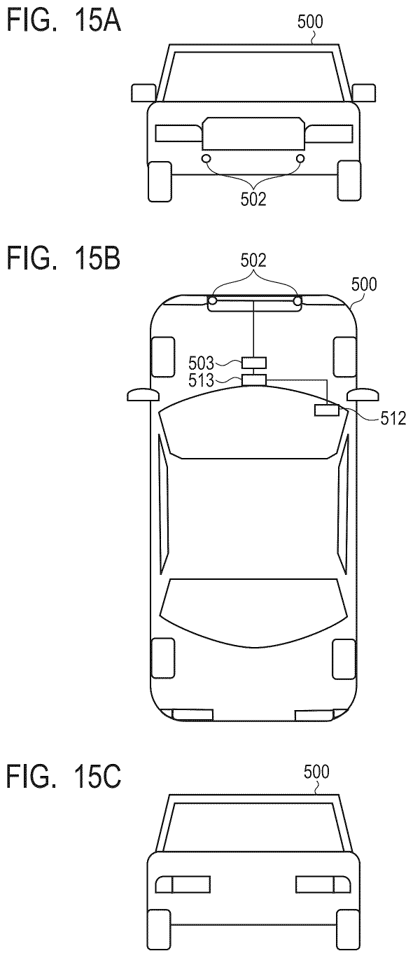

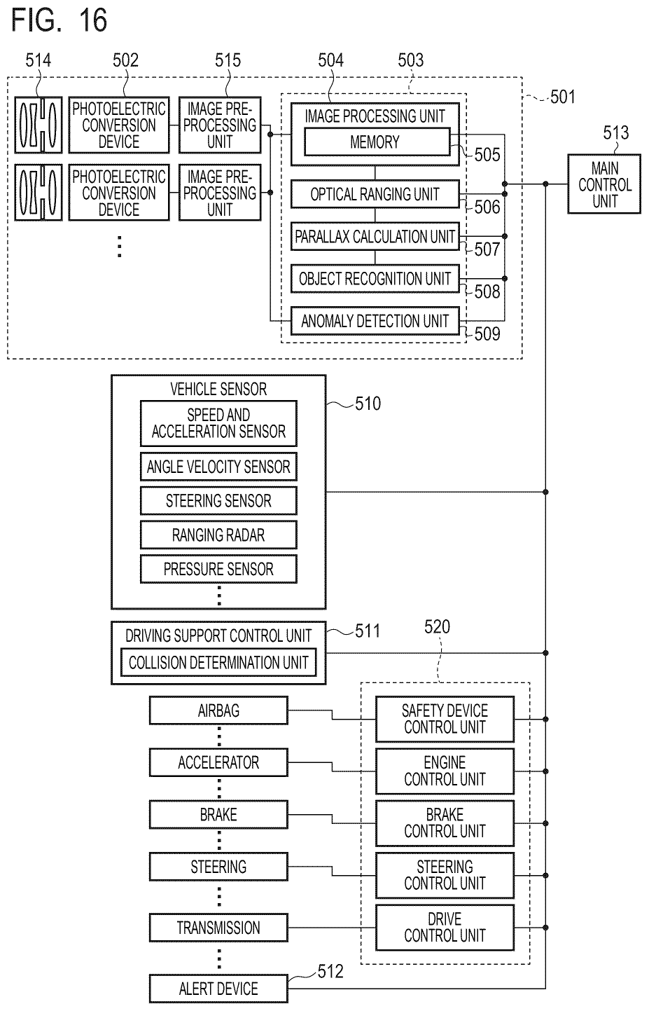

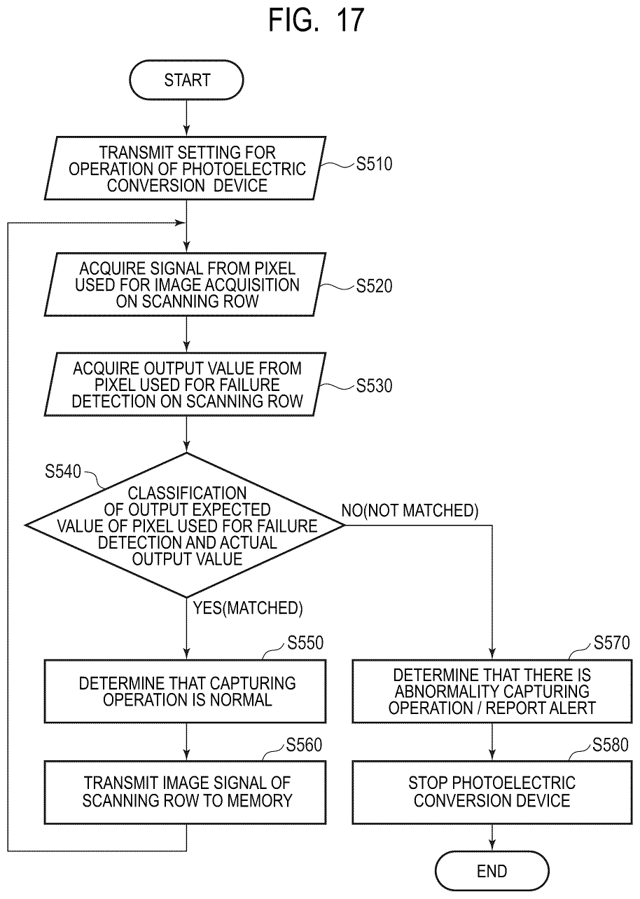

A photodetection system and a movable object according to an eighth embodiment will be described with reference to FIG. 15A to FIG. 17. FIG. 15A to FIG. 15C are schematic diagrams illustrating a configuration example of a movable object according to the present embodiment. FIG. 16 is a block diagram illustrating a schematic configuration of a photodetection system according to the present embodiment. FIG. 17 is a flowchart illustrating an operation of the photodetection system according to the present embodiment. In the present embodiment, an application example to an on-vehicle camera will be described as a photodetection system to which the photoelectric conversion device 100 according to any one of the first to fourth embodiments is applied.

FIG. 15A to FIG. 15C are schematic diagrams illustrating a configuration example of a movable object (vehicle system) according to the present embodiment. FIG. 15A to FIG. 15C illustrate a configuration of a vehicle 500 (automobile) as an example of a vehicle system incorporating a photodetection system to which the photoelectric conversion device according to any one of the first to fourth embodiments is applied. FIG. 15A is a schematic front view of the vehicle 500, FIG. 15B is a schematic plan view of the vehicle 500, and FIG. 15C is a schematic rear view of the vehicle 500. The vehicle 500 includes a pair of photoelectric conversion devices 502 on a front face thereof. Here, the photoelectric conversion device 502 is the photoelectric conversion device 100 described in any one of the first to fourth embodiments. The vehicle 500 includes an integrated circuit 503, an alert device 512, and a main control unit 513.

FIG. 16 is a block diagram illustrating a configuration example of the photodetection system 501 mounted on the vehicle 500. The photodetection system 501 includes photoelectric conversion devices 502, image preprocessing units 515, an integrated circuit 503, and optical systems 514. The photoelectric conversion device 502 is the photoelectric conversion device 100 described in any one of the first to fourth embodiments. The optical system 514 forms an optical image of an object on the photoelectric conversion device 502. The photoelectric conversion device 502 converts the optical image of the object formed by the optical system 514 into an electrical signal. The image preprocessing unit 515 performs predetermined signal processing on the signal output from the photoelectric conversion device 502. The function of the image preprocessing unit 515 may be incorporated in the photoelectric conversion device 502. At least two sets of the optical system 514, the photoelectric conversion device 502, and the image preprocessing unit 515 are provided in the photodetection system 501, and an output from the image preprocessing unit 515 of each set is input to the integrated circuit 503.

The integrated circuit 503 is an integrated circuit for an imaging system application, and includes an image processing unit 504, an optical ranging unit 506, a parallax calculation unit 507, an object recognition unit 508, and an abnormality detection unit 509. The image processing unit 504 processes the image signal output from the image preprocessing unit 515. For example, the image processing unit 504 performs image processing such as development processing and defect correction on the output signal of the image preprocessing unit 515. The image processing unit 504 includes a memory 505 that temporarily holds the image signal. In the memory 505, for example, the position of a known defective pixel in the photoelectric conversion device 502 may be stored.

The optical ranging unit 506 performs focusing and distance measurement of the object. The parallax calculation unit 507 calculates distance measurement information (distance information) from a plurality of image data (parallax images) acquired by the plurality of photoelectric conversion devices 502. Each of the photoelectric conversion devices 502 may have a configuration capable of acquiring various kinds of information such as distance information. The object recognition unit 508 recognizes an object such as a vehicle, a road, a sign, or a person.

Upon detecting an abnormality in the photoelectric conversion device 502, the abnormality detection unit 509 notifies the main control unit 513 of the abnormality.

The integrated circuit 503 may be realized by dedicatedly designed hardware, may be realized by a software module, or may be realized by a combination thereof. Further, it may be realized by a field programmable gate array (FPGA), an application specific integrated circuit (ASIC), or the like, or may be realized by a combination of these.

The main control unit 513 integrally controls the operations of the photodetection system 501, the vehicle sensor 510, the control unit 520, and the like. The vehicle 500 may not include the main control unit 513.

In this case, the photoelectric conversion device 502, the vehicle sensor 510, and the control unit 520 transmit and receive control signals via a communication network. For example, the controller area network (CAN) standard may be applied to the transmission and reception of the control signals.

The integrated circuit 503 has a function of receiving a control signal from the main control unit 513 or transmitting a control signal or a setting value to the photoelectric conversion device 502 by its own control unit.

The photodetection system 501 is connected to the vehicle sensor 510 and may detect a traveling state of the host vehicle such as a vehicle speed, a yaw rate, and a steering angle, an environment outside the host vehicle, and states of other vehicles and obstacles.

The vehicle sensor 510 is also a distance information acquisition unit that acquires distance information to the object. In addition, the photodetection system 501 is connected to a driving support control unit 511 that performs various kinds of driving support such as automatic steering, automatic traveling, and a collision prevention function. In particular, with respect to the collision determination function, the driving support control unit 511 estimates the collision with other vehicles or obstacles and determines whether or not there is a collision with other vehicles or obstacles based on the detection results of the photodetection system 501 and the vehicle sensor 510. Thus, avoidance control when a collision is estimated and activation of the safety device at the time of the collision are performed.

The photodetection system 501 is also connected to an alert device 512 that issues an alert to the driver based on the determination result of the collision determination unit. For example, when the determination result of the collision determination unit is that the possibility of a collision is high, the main control unit 513 performs vehicle control for avoiding a collision and reducing damage by applying a brake, returning an accelerator, suppressing engine output, or the like. The alert device 512 alerts the user by sounding an alarm such as a sound, displaying alert information on a display screen of a car navigation system, a meter panel, or the like, or vibrating a seat belt or a steering wheel.

In the present embodiment, an image of the surroundings of the vehicle, for example, the front or the rear, is captured by the photodetection system 501. FIG. 15B illustrates an arrangement example of the photodetection system 501 in a case where the photodetection system 501 captures an image in front of the vehicle.

As described above, the photoelectric conversion devices 502 are disposed in front of the vehicle 500. Specifically, it is preferable that a center line with respect to an advancing/retreating direction or an outer shape (for example, a vehicle width) of the vehicle 500 is regarded as a symmetry axis, and two photoelectric conversion devices 502 are disposed line-symmetrically with respect to the symmetry axis in order to acquire distance information between the vehicle 500 and an object to be imaged and determine a possibility of collision. In addition, the photoelectric conversion devices 502 are preferably disposed so as not to interfere with the driver's visual field when the driver visually recognizes a situation outside the vehicle 500 from the driver's seat. The alert device 512 is preferably disposed so as to easily enter the field of view of the driver.

Next, a failure detection operation of the photoelectric conversion device 502 in the photodetection system 501 will be described with reference to FIG. 17. The failure detection operation of the photoelectric conversion device 502 may be performed in accordance with steps S510 to S580 illustrated in FIG. 17.

Step S510 is a step of performing setting at the time of start-up of the photoelectric conversion device 502. That is, the setting for the operation of the photoelectric conversion device 502 is transmitted from the outside of the photodetection system 501 (for example, the main control unit 513) or the inside of the photodetection system 501, and the imaging operation and the failure detection operation of the photoelectric conversion device 502 are started.

Next, in step S520, pixel signals are acquired from the effective pixels. In step S530, an output value from a failure detection pixel provided for failure detection is acquired. The failure detection pixel may include a photoelectric conversion element in the same manner as the effective pixel. A predetermined voltage is written to the photoelectric conversion element of the failure detection pixel. The failure detection pixel outputs a signal corresponding to the voltage written in the photoelectric conversion element. Note that step S520 and step S530 may be reversed.

Next, in step S540, a classification of the output expected value of the failure detection pixel and the actual output value from the failure detection pixel is performed. As a result of the classification in step S540, when the output expected value matches the actual output value, the process proceeds to step S550, it is determined that the imaging operation is normally performed, and the process step proceeds to step S560. In step S560, the pixel signals of the scanning row are transmitted to the memory 505 and temporarily stored. After that, the process returns to step S520 to continue the failure detection operation. On the other hand, as a result of the classification in step S540, when the output expected value does not match the actual output value, the processing step proceeds to step S570. In step S570, it is determined that there is an abnormality in the imaging operation, and an alert is notified to the main control unit 513 or the alert device 512. The alert device 512 causes the display unit to display that an abnormality has been detected. Thereafter, in step S580, the photoelectric conversion device 502 is stopped, and the operation of the photodetection system 501 is ended.

In the present embodiment, an example in which the flowchart is looped for each row is described, but the flowchart may be looped for each plurality of rows, or the failure detection operation may be performed for each frame. The alert of step S570 may be notified to the outside of the vehicle via a wireless network.

In addition, in the present embodiment, the control in which the own vehicle does not collide with another vehicle has been described, but the present disclosure is also applicable to control in which the own vehicle follows another vehicle and performs automatic driving, control in which the vehicle performs automatic driving so as not to protrude from a lane, and the like. Further, the photodetection system 501 is not limited to a vehicle such as an own vehicle, and may be applied to, for example, other movable object (mobile device) of a ship, an aircraft, an industrial robot, or the like. In addition, the present disclosure is not limited to movable object and may be widely applied to equipment using object recognition, such as intelligent transport systems (ITS).

### Ninth Embodiment

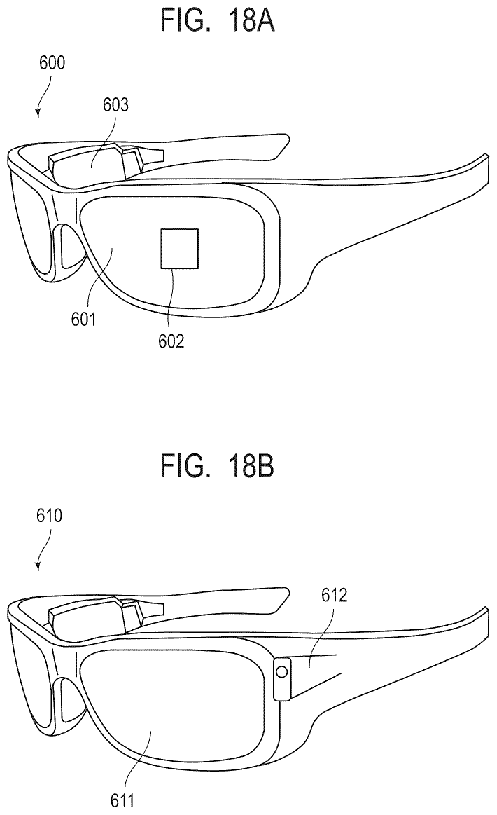

A photodetection system according to a ninth embodiment will be described with reference to FIG. 18A and FIG. 18B. FIG. 18A and FIG. 18B are schematic diagrams illustrating configuration examples of a photodetection system according to the present embodiment. In the present embodiment, an application example to eyeglasses (smart glasses) will be described as a photodetection system to which the photoelectric conversion device 100 according to any one of the first to fourth embodiments is applied.

FIG. 18A illustrates eyeglasses 600 (smart glasses) according to one application example. The eyeglasses 600 include lenses 601, a photoelectric conversion device 602, and a control device 603.

The photoelectric conversion device 602 is the photoelectric conversion device 100 described in any one of the first to fourth embodiments and is provided on the lens 601. One photoelectric conversion device 602 may be provided, or a plurality of photoelectric conversion devices may be provided. When a plurality of photoelectric conversion devices 602 is used, a combination of a plurality of types of photoelectric conversion devices 602 may be used. The arrangement position of the photoelectric conversion device 602 is not limited to FIG. 18A. A display device (not illustrated) including a light emitting device such as an organic light emitting diode (OLED) or an LED may be provided on the back surface side of the lens 601.

The control device 603 functions as a power supply that supplies power to the photoelectric conversion device 602 and the display device. The control device 603 has a function of controlling the operations of the photoelectric conversion device 602 and the display device. The lens 601 may be provided with an optical system for focusing light on the photoelectric conversion device 602.

FIG. 18B illustrates eyeglasses 610 (smart glasses) according to another application example. The eyeglasses 610 include lenses 611 and a control device 612. A photoelectric conversion device (not illustrated) corresponding to the photoelectric conversion device 602 and the display device may be mounted on the control device 612.

The lens 611 is provided with a photoelectric conversion device in the control device 612 and an optical system for projecting light from the display device, and an image is projected thereon. The control device 612 functions as a power supply that supplies power to the photoelectric conversion device and the display device and has a function of controlling operations of the photoelectric conversion device and the display device.

The control device 612 may further include a line-of-sight detection unit that detects the line of sight of the wearer. In this case, an infrared light emitting unit may be provided in the control device 612, and infrared light emitted from the infrared light emitting unit may be used for detection of a line of sight. Specifically, the infrared light emitting unit emits infrared light to the eyeball of the user who is watching the display image. A captured image of the eyeball is obtained by detecting reflected light of the emitted infrared light from the eyeball by an imaging unit having a light receiving element. By providing a reduction unit that reduces light from the infrared light emitting unit to the display unit in a plan view, it is possible to reduce degradation of image quality.

The line of sight of the user with respect to the display image may be detected from the captured image of the eyeball obtained by capturing the infrared light. Any known technique may be applied to the line-of-sight detection using the captured image of the eyeball. As an example, a line-of-sight detection method based on a Purkinje image due to reflection of irradiation light on the cornea may be used. More specifically, the line-of-sight detection process based on the pupil corneal reflection method is performed. The line of sight of the user may be detected by calculating a line-of-sight vector representing the orientation (rotation angle) of the eyeball based on the image of the pupil included in the captured image of the eyeball and the Purkinje image using the pupil corneal reflex method.

The display device according to the present embodiment may include a photoelectric conversion device having a light receiving element, and may be configured to control a display image based on line-of-sight information of a user from the photoelectric conversion device. Specifically, the display device determines, based on the line-of-sight information, a first viewing area that the user gazes at and a second viewing area other than the first viewing area. The first viewing area and the second viewing area may be determined by a control device of the display device or may be determined by an external control device. When the determination is made by the external control device, the determination result is transmitted to the display device via communication. In the display area of the display device, the display resolution of the first viewing area may be controlled to be higher than the display resolution of the second viewing area. That is, the resolution of the second viewing area may be lower than the resolution of the first viewing area.

The display area may include a first display area and a second display area different from the first display area, and an area having a high priority may be determined from the first display area and the second display area based on the line-of-sight information. The first display area and the second display area may be determined by a control device of the display device or may be determined by an external control device. When the determination is made by the external control device, the determination result is transmitted to the display device via communication. The resolution of the high priority area may be controlled to be higher than the resolution of the area other than the high priority area. That is, the resolution of the area having a relatively low priority may be lowered.

Note that an artificial intelligence (AI) may be used to determine the first viewing area or the area with a high priority. The AI may be a model configured to estimate an angle of the line of sight and a distance to a target object ahead of the line of sight from the image of the eyeball using the image of the eyeball and the direction in which the eyeball of the image is actually viewed as teacher data. The AI program may be included in the display device, the photoelectric conversion device, or the external device. When the external device has the program, the information may be transmitted to the display device via communication.

In the case of performing display control based on visual recognition detection, the present disclosure may be preferably applied to smart glasses further including a photoelectric conversion device that captures an image of the outside. Smart glasses may display captured external information in real time.

### Modified Embodiments

The present disclosure is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

For example, in the above embodiment, the event detection determination is performed by comparing the time count value of the time information counter 366 with the time count value of the previous frame stored in the memory 368, but the comparison target may not necessarily be the time count value of the immediately preceding frame.

For example, the comparison target may be a time count value two or more frames before. Alternatively, the time count values for several frames may be stored in the memory 368, and the event detection determination may be performed according to the magnitude of the variation of the time count values for the several frames.

Further, in the above-described embodiment, the recharge method of periodically performing the recharge of the APD 22 is applied as the quenching circuit 32, but the quenching circuit 32 does not necessarily need to be the recharge method. For example, the p-channel MOS transistor Mq driven by the periodic signal may be replaced with a resistor or an active quenching circuit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the present disclosure, and the technical scope of the present disclosure should not be interpreted in a limited manner by these embodiments. That is, the present disclosure can be implemented in various forms without departing from the technical idea or the main features thereof.

According to the present disclosure, it is possible to realize a photoelectric conversion device and a photodetection system capable of acquiring a high dynamic range image and detecting an event while suppressing power consumption.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-142355, filed Aug. 23, 2024, which is hereby incorporated by reference herein in its entirety.

What is claimed is:

1. A photoelectric conversion device comprising:
a photoelectric conversion unit configured to output a pulse signal in response to incidence of a photon;
a first counter configured to count the pulse signal;
an exposure control circuit configured to control a count period of the pulse signal by the first counter according to a result of a plurality of comparisons of a count value of the first counter with a predetermined threshold value during an exposure period of one frame;
a second counter configured to count each time it is determined that the count value of the first counter is equal to or less than the threshold value; and
a comparison circuit configured to compare a count value of the second counter in a first frame with a count value of the second counter in a second frame before the first frame and output event information according to a comparison result.

2. The photoelectric conversion device according to claim 1, wherein the exposure control circuit ends the count period when the count value of the first counter exceeds the threshold value.

3. The photoelectric conversion device according to claim 1, wherein, when the count value of the first counter does not exceed the threshold value in each of the plurality of comparisons, the exposure control circuit ends the count period when the exposure period elapses.

4. The photoelectric conversion device according to claim 1, wherein the second counter counts up each time it is determined that the count value of the first counter is equal to or less than the threshold value.

5. The photoelectric conversion device according to claim 1, wherein, when the count value of the second counter in the first frame is different from the count value of the second counter in the second frame, the comparison circuit outputs the event information indicating that an event has been detected.

6. The photoelectric conversion device according to claim 1, further comprising: a memory configured to hold a count value of the second counter when the count period ends,
wherein the memory stores the count value of the second counter after the count period has ended and before transitioning to a next frame.

7. The photoelectric conversion device according to claim 1,
wherein the comparison circuit further compares high-order bit information of the first counter when the count period ends in the first frame with high-order bit information of the first counter when the count period ends in the second frame, and
wherein the comparison circuit outputs the event information indicating that an event has been detected, when the count value of the second counter in the first frame is the same as the count value of the second counter in the second frame and the high-order bit information of the first counter in the first frame is different from the high-order bit information of the first counter in the second frame.

8. The photoelectric conversion device according to claim 7, further comprising: a memory configured to store the high-order bit information of the first counter when the count period ends.

9. The photoelectric conversion device according to claim 1, the comparison circuit outputs the event information before the exposure period elapses.

10. The photoelectric conversion device according to claim 1, wherein the count value of the first counter and the count value of the second counter are output as image information after the count period ends.

11. The photoelectric conversion device according to claim 1, wherein the number of bits of the second counter is smaller than the number of bits of the first counter.

12. The photoelectric conversion device according to claim 1,
wherein a time T1, a time T2, . . . , and a time TN are represented by T/m^{N}, T/m^{N-1}, . . . , and T/m¹, respectively, where T is a length of the exposure period, N is the number of times the count value of the first counter is compared with the threshold value during the exposure period, the time T1, the time T2, . . . , and the time TN are times at which the count value of the first counter is compared with the threshold value, and m is an arbitrary integer of 2 or more,
wherein the threshold value is represented by Nsat/m, where Nsat is a saturation value of the first counter, and
wherein m is a power of two.

13. A photoelectric conversion device comprising:
a photoelectric conversion unit configured to output a pulse signal in response to incidence of a photon;
a first counter configured to count the pulse signal;
a second counter configured to count a time until the first counter reaches a predetermined threshold value; and
a comparison circuit configured to compare a count value of the second counter in a first frame with a count value of the second counter in a second frame before the first frame and output event information according to a comparison result.

14. The photoelectric conversion device according to claim 13, wherein the comparison circuit outputs the event information indicating that an event has been detected when the count value of the second counter in the first frame is different from the count value of the second counter in the second frame.

15. The photoelectric conversion device according to claim 13, wherein the comparison circuit outputs the event information indicating that an event has been detected when a difference between the count value of the second counter in the first frame and the count value of the second counter in the second frame exceeds a predetermined value.

16. The photoelectric conversion device according to claim 13, wherein the threshold value is a count upper limit value of the first counter.

17. The photoelectric conversion device according to claim 1,
wherein the photoelectric conversion unit includes an avalanche photodiode, and a control circuit that periodically controls the avalanche photodiode according to a periodic signal to a standby state in which avalanche multiplication is possible, and to a recharge state in which the avalanche photodiode returns to a state in which avalanche multiplication is possible again after avalanche multiplication occurs, and
wherein the first counter counts the pulse signal output corresponding to a period in which the avalanche multiplication occurs among the periods in which the avalanche photodiode is in the standby state.

18. A photodetection system comprising:
the photoelectric conversion according to claim 1; and
a signal processing device configured to process a signal output from the photoelectric conversion device.

19. The photodetection system according to claim 18, wherein the signal processing device generates a distance image representing distance information to an object based on the signal.

20. A movable object comprising:
the photoelectric conversion device according to claim 1;
a distance information acquisition device configured to acquire distance information to an object from a parallax image based on a signal output from the photoelectric conversion device; and
a control device configured to control the movable object based on the distance information.
